(19) United States
(12) Patent Application Publication
(10) Pub. No.: US 2001/0034742 A1
(43) Pub. Date: Oct. 25, 2001

(54) Apparatus, method and system for a temporal interface, interpretive help, directed searches, and dynamic association mapping

(76) Inventor: Konata Stinson, New York, NY (US)

Correspondence Address: MORGAN & FINNEGAN, L.L.P., 345 Park Avenue, New York, NY, 10154, US

(21) Appl. No.: 09/761,617

(22) Filed: Jan. 16, 2001

Related U.S. Application Data
(60) Provisional application No. 60/176,470, filed on Jan. 17, 2000.
(60) Provisional application No. 60/176,614, filed on Jan. 18, 2000.

(51) Int. Cl. G06F 17/30; G06F 17/21

(52) U.S. Cl. 707/501.1; 707/500.1

(57) ABSTRACT

The present invention is a method, apparatus, and system for improving the ability to access, map, search, navigate, and visualize complicated bodies of related information, for example, bodies such as the World Wide Web. A temporal user interface allows users to visualize complex data sets. In one embodiment, this is done by viewing data set representations as raindrops in a pool of water across the time span of a rain storm. Also, the present invention dynamically analyzes and maps information to provide relevant information for a user to view. In one embodiment, the dynamic analysis mapping of information is displayed over time in the temporal user interface. The present invention further provides a mechanism allowing a user to perform directed searches. This allows the user to provide a relevant starting point, subject matter, and a number of other criteria to the search facility that results in search results that are more meaningful. Finally, the present invention provides an interpretive help facility. The interpretive help facility can analyze the users history of actions and provide relevant help based on those actions. The interpretive help facility also allows the user correct mistakes.

This application claims priority under 35 USC § 119(e) to provisional application Ser. No. 60/176,470, filed Jan. 17, 2000 and provisional application Ser. No. 60/176,614, filed Jan. 18, 2000, each of which are incorporated herein by reference.

### FIELD

The present invention generally relates to computer software, devices and methods, and more particularly to computer interfaces, search, help, and relational facilities.

### BACKGROUND

A wide variety of machinery, systems, and methods exist, which allow for the interaction, viewing, mapping, and searching of information systems. The proliferation and expansion of computer systems and the Internet, and particularly the World Wide Web (WWW), has resulted in a vast and diverse collection of information organized as hypertext. Various interaction interfaces (user interfaces) exist that facilitate the interaction of people with computer systems. Graphical user interfaces provided by likes of the Apple Macintosh Operating System, or Microsoft's Windows 98, provide a baseline and means of accessing and displaying information. Also, the advance of the WWW has provided information navigation interfaces, also known as web browsers, such as Microsoft's Internet Explorer and Netscape Navigator, as well as navigation interface devices such as WebTV. Many of these user interfaces also have context sensitive help system facilities customarily, which are accessed through menu selections, keyboard entries, and allow for searches. Examples of these interfaces include the Microsoft Windows Help System, Apple's Macintosh Operating System balloon help, and popup help systems.

Information on the WWW is encoded in HyperText Markup Language (HTML); HTML documents are also commonly referred to as web pages. HTML documents may contain links to other HTML documents that can be traversed by users of graphical user interfaces and web browsers by selecting the links, which are commonly highlighted by color and underlining. Web browsers, originally developed on NeXT Computer Inc.'s operating system NeXTSTEP and now widely available on almost every operating system platform, allow users to access uniquely identified documents in the WWW by entering a navigation location in a Universal Resource Locator (URL) facility. The URL is the address or navigation location for a resource accessible on the Internet. The basic paradigm presents users with a scrolling page full of text, pictures, and various other forms of information media such as movies, and links to other documents. The vastness of the WWW has resulted in the proliferation of web search engines such as Yahoo, AltaVista, and Google to facilitate the finding of relevant information. These web search engines take search requests entered into a web page, or user interface intermediary like Apple's Sherlock, and typically return links (i.e., navigation locations) that the user may traverse.

Various attempts have been made to improve search engine strategies. One such strategy is knows as the fish search which is discussed in greater detail in: dr. P.M.E. De Bra & drs. R.D.J. Post, Searching for Arbitrary Information in the WWW: the Fish-Search for Mosaic (visited Jan. 13, 2000) www.ncsa.uiuc.edu/SDG/IT94/Proceedings/Seardching/debra/articl e.html. Another similar search strategy is known as the shark search wish is discussed in greater detail in: Michael Hersovici, et al., The shark-search algorithm-An application: tailored Web site mapping (visited Jan. 13, 2000) www7.scu.edu.au/programme/fullpapers/1849/com1849.htm.

Data mapping interfaces have been improved providing interfaces to better examine and maneuver through the WWW such as: IBM's Mappaccino, Michael Hersovici, et al., The sharksearch algorithm-An application: tailored Web site mapping (visited Jan. 13, 2000) www7.scu.edu.au/programme/fullpapers/1849/com1849.htm; Nestor, Romain Zeiliger, Claire Belisle, et al., Implementing a Constructivist Approach to Web Navigation support (visited Jan. 13, 2000) www.irpeacs.fr/˜zeiliger/artem99.htm; and Natto, The Natto View (visited Jan. 13, 2000) www.myo.inst.keio.ac.jp/NattoView/.

### SUMMARY

As set forth below, a need exists for an improved apparatus, method, and system for allowing users to access and traverse wide and diverse collections of information. The user interfaces that allow for the traversing the WWW have left users confused and overwhelmed with the resulting displays, formation, and provisions for traversing.

The proliferation of information has stressed the functionality of current user interfaces. The sheer magnitude of interrelated information, offered on the WWW alone, is staggering. Old user interface paradigms such as the desktop metaphor provided by Microsoft Windows were sufficient to handle the access and navigation of locally stored information. However, with the advent and proliferation of network communications, such desktop paradigms have been stressed. The easy location, navigation and access of a few documents maps well to a desktop metaphor. However, even with relatively modest sized Local Area Networks (LANs), the ability to easily find, access, and navigate through data has been hampered to the point where new paradigms of information access were developed. Web browsers presented a user interface that allowed users to access information with less regard to physical location. However, the sheer vastness of information on the Internet and its distributed and decentralized nature makes it exceedingly difficult to find relevant and particular documents, save and manage navigation locations of interest, or navigate about related, relevant information of interest to the user. For example, in Netscape Navigator, the user is not provided with a visual representation of their location in context with other related locations and materials. If a user performs a search in a web search engine such as AltaVista, many outdated and irrelevant documents are returned. Along with the sheer amount of info available, its dynamic nature (i.e., Web sites and pages constantly being created, moved or removed) hampers traditional search engines. When the user does find several relevant documents, there is no easy way to save or view the group of documents (or the subweb); to accomplish this, the user must create a category in their bookmarks facility and access and save each document of interest, thus, burdening them with this menial organizational task.

Projects such as IBM's Mappaccino, Natto, and others of the like have sought to improve mapping, searching, access, and navigation of information with limited success. The interfaces provided by the aforementioned have been confusing, cumbersome, and unintuitive. They produce very crowded directed graphs that provide few cues as to what information may be found or useful at the represented navigation location, typically in incredibly cluttered views. Even going into a third dimension with projects such as Natto have not eased matters. There has been no tight, visceral, and dynamic integration and representation of information, mapping, or navigation presented to the user for such data access until the present invention.

The present invention provides a radical new paradigm in allowing the user to interact and access this enormous base of information. The fundamental premise is to provide a temporal interface to facilitate the navigation of information. The view presented to the user is that of a (liquid) data pool either atop their desktop interface, in a separate window, or in a subview of a window or the like. Into this pool (in one embodiment, represented as water) information rains. The raindrops disturb the water similarly to how such natural phenomena occurs causing ripples. The raindrops in proximity to one another represent related information to the user. If a user does not interact with a raindrop, the information fades with time and the water calms as the raindrops dissolve until new raindrops appear.

This pool allows the easy representation of vast, fluid, and complex mappings such as WWW and its subwebs. This user interface paradigm in conjunction with more intelligent dynamic analysis and mapping techniques gives a user a facility to easily and more readily access, find, and navigate data. Dynamic analysis tools such as the shark search have been greatly stunted by limited analysis techniques and a fundamental barrier in the assimilation of information to be presented in meaningful manners.

Finally, the present invention further facilitates user interaction with data by advancing the art of help systems. The current state of the art help is problematic to many users in that it requires the user to know a priori that which she needs help with. For example, when searching the help system in Microsoft Windows, one must guess the proper term or recognize the term in an index. This facility has been somewhat extended to context sensitive help. The context sensitive help allows the user to engage a modifier key, commonly the F1 key, and select a user interface element, which will bring up a related help file. This is problematic when the user is trying to figure out what she is doing wrong because it does not interpret the user's actions. Rather, the user must fumble about the screen making selections hoping to guess the right element to select for help. The present invention analyzes and interprets the user's actions to guide them to a proper source for help and allows them to undo any mistakes they may have made.

The above advantages and features are of representative embodiments only, and are not exhaustive and/or exclusive. They are presented only to assist in understanding the invention. It should be understood that they are not representative of all the inventions defined by the claims, to be considered limitations on the invention as defined by the claims, or limitations on equivalents to the claims. For instance, some of these advantages may be mutually contradictory, in that they cannot be simultaneously present in a single embodiment. Similarly, some advantages are applicable to one aspect of the invention, and inapplicable to others. Furthermore, certain aspects of the claimed invention have not been discussed herein. However, no inference should be drawn regarding those discussed herein relative to those not discussed herein other than for purposes of space and reducing repetition. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

The accompanying drawings illustrate certain embodiments of the invention.

FIG. 1 illustrates a centralized controller according to one embodiment of the present invention;

FIG. 2 illustrates another embodiment of the present invention in the form of a distributed system interacting through a communications network;

FIG. 3 illustrates another embodiment of the system and various interactions;

FIG. 4 illustrates web pages, hypertext, reference and proximal links. 2;

FIG. 5 is a flowchart illustrating dynamic analysis mapping;

FIG. 6 is a flowchart illustrating a directed search;

FIG. 7 is a flowchart illustrating a dynamic directed search;

FIG. 8 is a flowchart illustrating an interpretive help facility;

FIG. 9 is an illustration of a temporal user interface;

FIG. 10 is a close up illustration of a temporal user interface;

FIG. 11 is an illustration of a temporal user interface with a selection being made;

FIG. 12 is an illustration of a temporal user interface focusing on information;

FIG. 13 is an illustration of a temporal user interface focusing on information;

FIG. 14 is an illustration of a temporal user interface windowfying on information;

FIG. 15 is an illustration of a temporal user interface deleting raindrops;

FIG. 16 is an illustration of a temporal user interface navigating through data by time;

FIG. 17 is an illustration of a temporal user interface with a skimming pebble;

FIG. 18 is a flowchart illustrating the display flow of a temporal user interface; and

FIG. 19 is a flowchart illustrating the generation flow of a temporal user interface.

### DETAILED DESCRIPTION

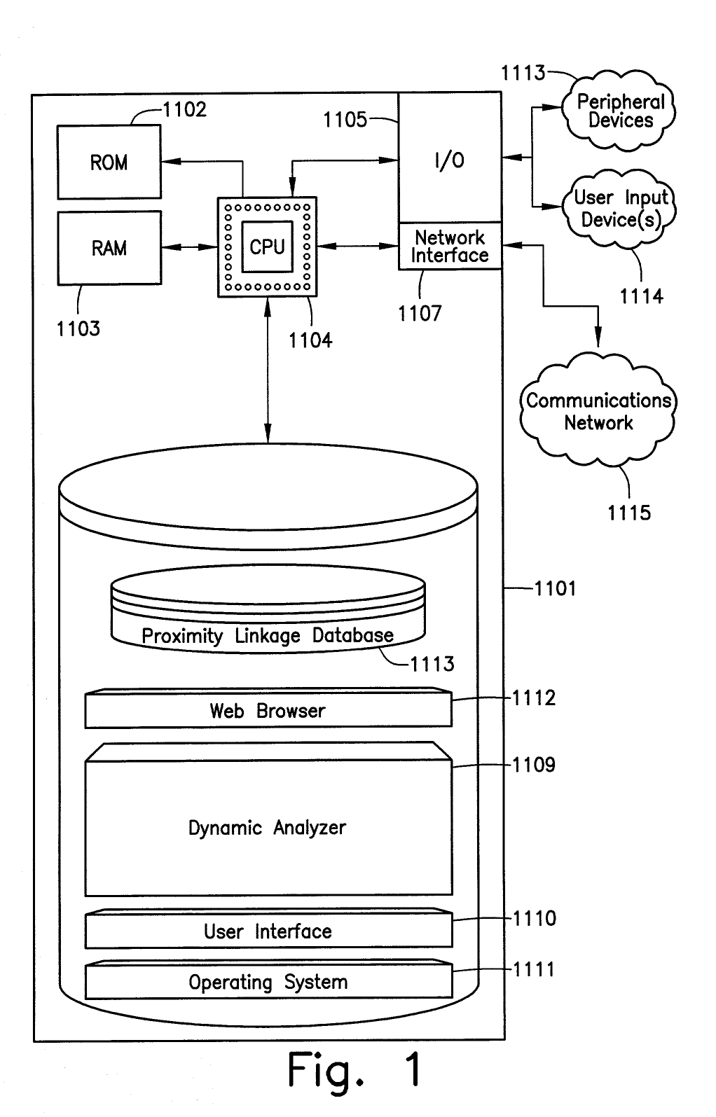

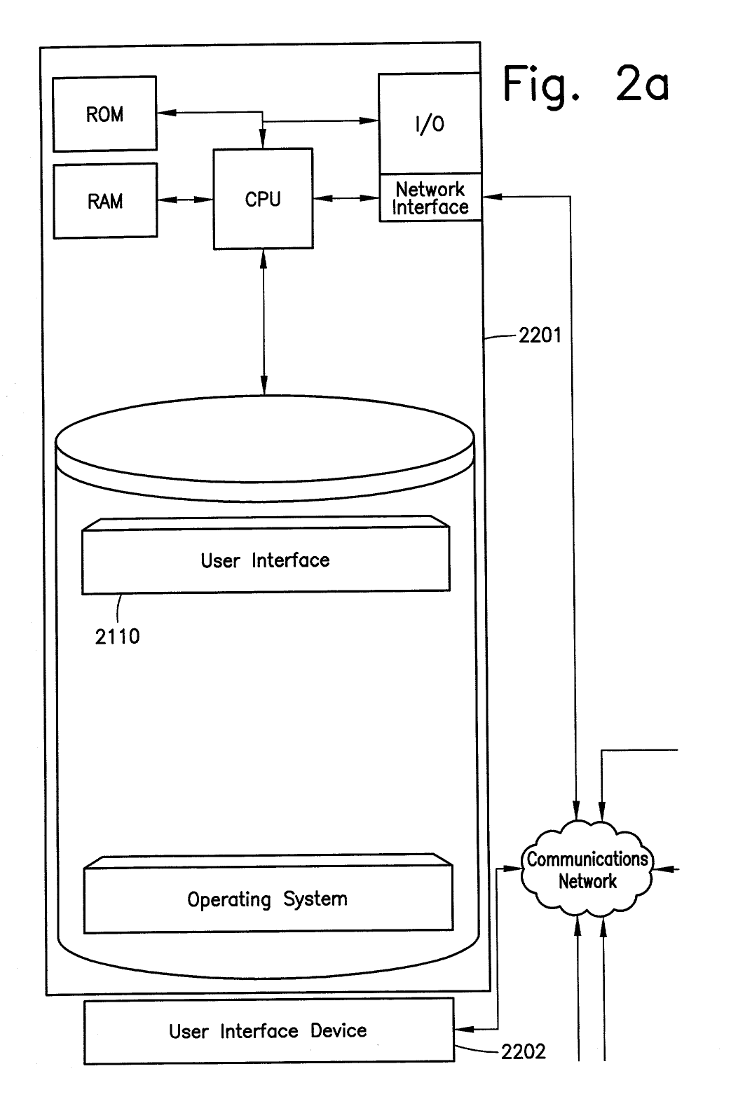

FIG. 1 shows one embodiment of a system incorporating the present invention. In this embodiment, the system includes a centralized controller 1101 configured to receive information from one or more users from user input device(s) 1114. Also, the centralized controller may receive information from a communications network 1115 through its input/output (I/O) facility 1105, preferably, via a network interface 1107. The I/O facility is capable of both receiving and sending information. Peripheral devices 1113 may be attached to the dynamic analyzer for any number of purposes including, but not limited to: printers for output, scanners for input, additional or alternative storage devices for data storage and retrieval, network interfaces for communication, and devices of the like.

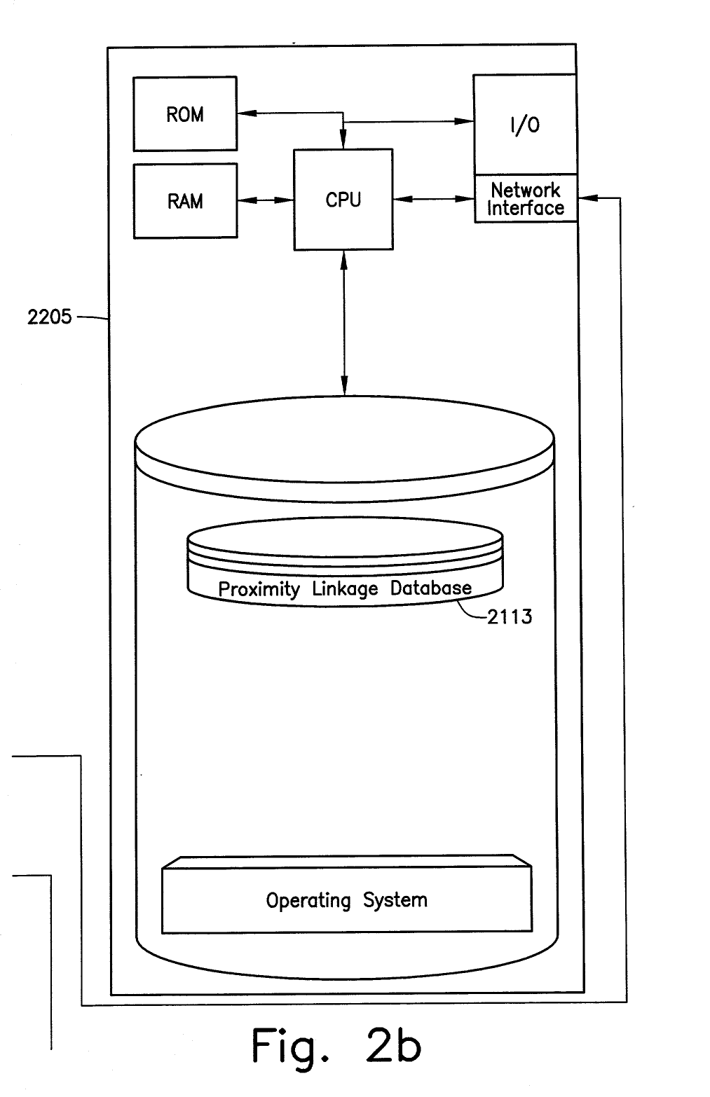

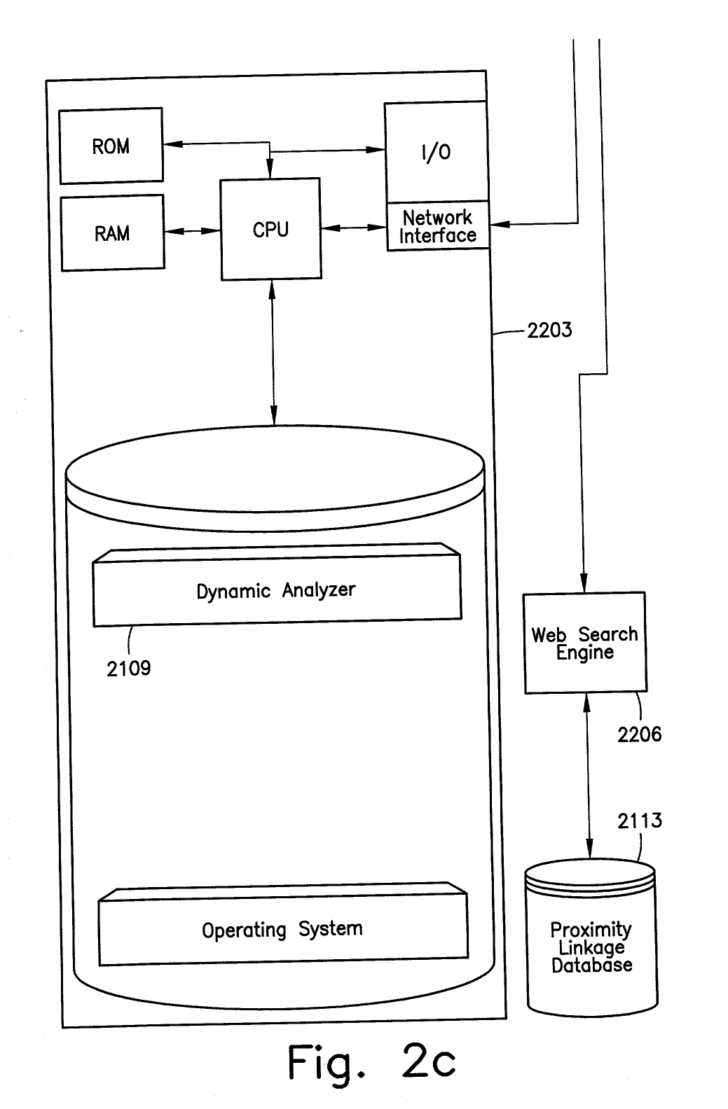

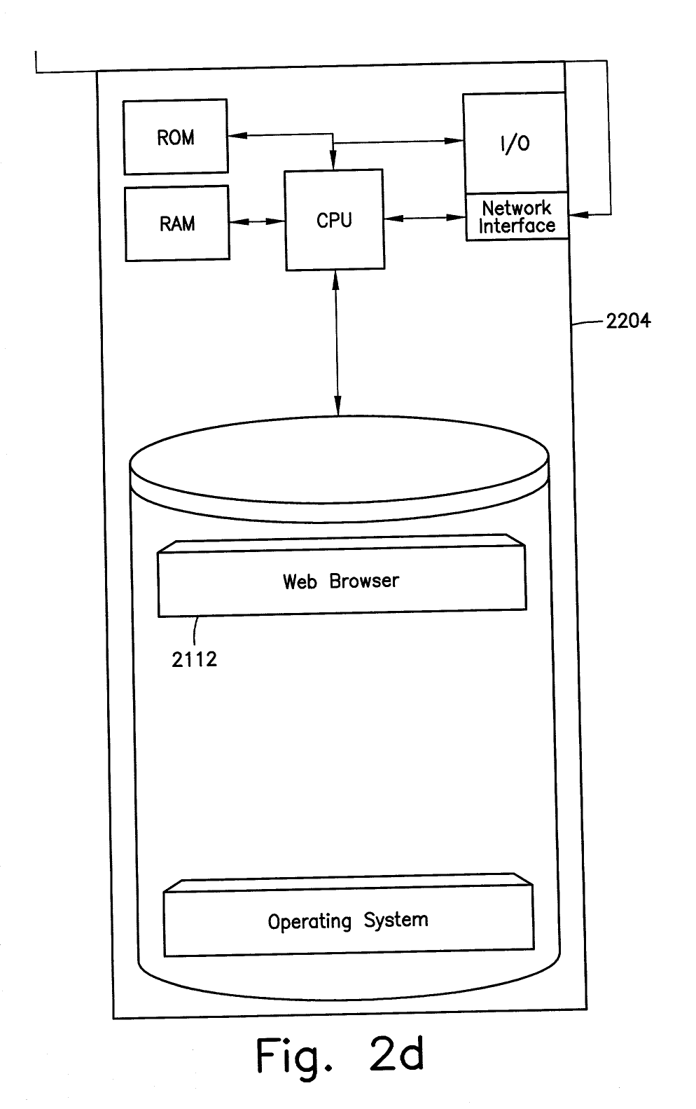

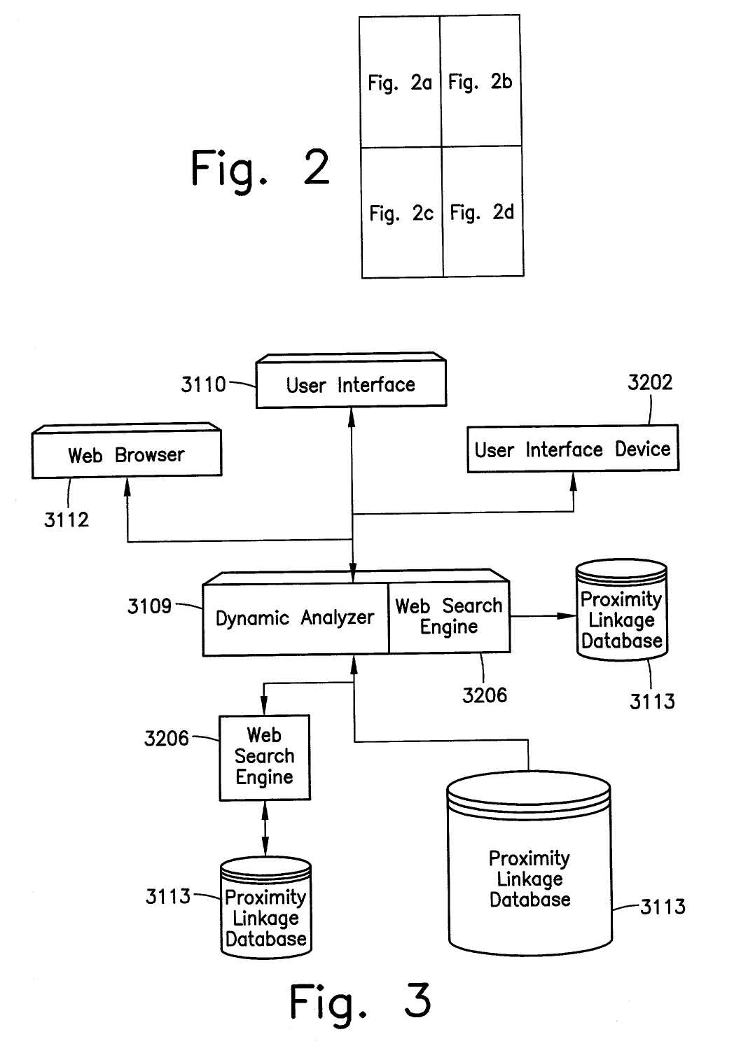

The centralized controller includes a central processing unit (CPU) 1104, random access memory (RAM) 1103, read only memory 1102, and a local storage device 1108. The CPU is electronically coupled to each of the central controller's other elements. The CPU comprises at least one high-speed data processor adequate to execute program modules for executing user or system generated requests. These modules are described in FIGS. 2 through 17. Preferably, the CPU is a conventional microprocessor such as the Intel Pentium Processor. The CPU interacts with RAM, ROM, and storage device(s) to execute stored program code according to conventional data processing techniques.

The local storage device may contain modules. These modules may include, but are not limited to, a dynamic analyzer 1109, a user interface 1110, an operating system 1111, a web browser 1112 and a proximity linkage database 1113. These modules may be stored and accessed from the local storage device(s) or from storage devices accessible through I/O. Although these modules typically and preferably are stored in a local storage device, they may also be stored in ROM, RAM, peripheral devices or in remote storage facilities through a communications network.

The operating system is executable program code enabling the operation of a centralized controller. The operating system facilitates access of storage devices, I/O, network interfaces devices, peripheral devices, etc. The operating system preferably is a conventional product such as the Unix operating system or Microsoft Windows NT. The operating system, once executed by the CPU, interacts with ROM, RAM, I/O, peripheral devices, user input devices, storage devices, communications networks, program modules, and data, et al. Preferably, the operating system includes communication protocols that allow the centralized controller to communicate with other entities through a communications network. The preferable protocol is TCP/IP.

FIG. 2 shows another embodiment of a system incorporating the present invention. In this embodiment, the centralized controller 1101 embodiment of FIG. 1 has been decentralized into four components: a user interface controller 2201 or alternatively a user interface device 2202, a dynamic analyzer controller 2203, a web browser controller 2204, a proximity linkage database controller 2205, and a communications-network navigation-location search engine (e.g., web search engine, a local crawler search engine, etc.) 2206.

A user interface controller is comprised similarly to the centralized controller of FIG. 1 except it does not require a proximity linkage database, dynamic analyzer, or web browser. A user interface 2110 is stored program code that is executed by the CPU. The user interface is responsible for receiving either user or system generated requests.

In alternative embodiments, a user interface device 2202 may take the place of or be used in conjunction with a user interface controller. The user interface device may be a telephone, a consumer electronics device online access device (e.g., Phillips Inc.'s WebTV), PDA or the like.

A dynamic analyzer controller is comprised similarly to the centralized controller of FIG. 1 except it does not require a proximity linkage database, web browser, or user interface. The dynamic analyzer 2109 is stored program code that is executed by the CPU. A dynamic analyzer takes requests from a user interface and provides results to a user interface. The dynamic analyzer may also take system requests.

A proximity linkage database controller is comprised similarly to the centralized controller of FIG. 1 except it does not require a dynamic analyzer, web browser, or user interface. A proximity linkage database(s) 2113 is stored program code that is executed by the CPU and it is stored data processed by the CPU. A proximity linkage database takes requests from a dynamic analyzer and provides results to a dynamic analyzer. The proximity linkage database may also take system requests. In an alternative embodiment, a dynamic analyzer may be integrated into a linkage database or vice versa, thus combining the functionality of both. In yet another alternative embodiment, a dynamic analyzer may be integrated into a user interface or vice versa, thus, combining the functionality of both.

A web browser controller is comprised similarly to the centralized controller of FIG. 1 except it does not require a dynamic analyzer, proximity linkage database, or user interface. A web browser 2112 is stored program code that is executed by the CPU. Preferably, the web browser is a conventional hypertext viewing application such as Microsoft Internet Explorer or Netscape Navigator. Preferably, the web browser allows for the execution of program modules through facilities such as Java, JavaScript, ActiveX or the like. A web browser takes requests from a user interface and provides results to a user interface. The web browser may also take system requests. In alternative embodiments, a web browser may be integrated into a user interface or vice versa, thus, combining the functionality of both.

There are several types of web search engines available. One type is the automated web scanner that has been reading all the information in the World Wide Web (WWW) and indexing hypertext content for reference in databases; i.e., monolithic web search engines. Examples include the likes of Alta Vista, Google, and Yahoo. There are also local web search engines that run on a user's computer and search the WWW (sometimes referred to as “local crawlers”). Such a local web search engine may be integrated into or with a dynamic analyzer, or the dynamic analyzer may communicate with automated web scanners. Although it is not necessary, it is preferable to both integrate a web search engine into the dynamic analyzer and to access an external web search engine. Furthermore, the dynamic analyzer may refer to multiple web search engines at once, either integrated or remote. Although some of the above examples reference technologies and web search engines that index and allow for the search of the Internet, they may be expanded or limited to search other types of communications networks as well.

The functionality of the user interface controller, dynamic analyzer controller, proximity linkage database controller, web browser controller, and web search engine may be combined in any number of ways to facilitate deployment. To accomplish this, one may simply copy the executable code, first ensuring it has been compiled for the appropriate CPU of the controller for which it is destined, and/or data on to local storage device of one of the various controllers. Similarly, the functionality of the user interface, dynamic analyzer, proximity linkage database, web browser, and web search engine may be combined in any number of ways to facilitate deployment. To accomplish this, one must simply integrate the components into one code base or in a facility that can dynamically load the components on demand in an integrated fashion.

FIG. 3 shows an overview of the basic interaction of the system. The dynamic analyzer 3109 acts as an in-between for: a user interface 3110 on a system, a user interface device 3202, or a web browser 3112 taking requests; and following user actions and enhancing navigation by referring to proximity linkage databases 3113 either directly or through web search engines 3206. It shows that the dynamic analyzer may service multiple sources at once, and that the dynamic analyzer may access more than one database.

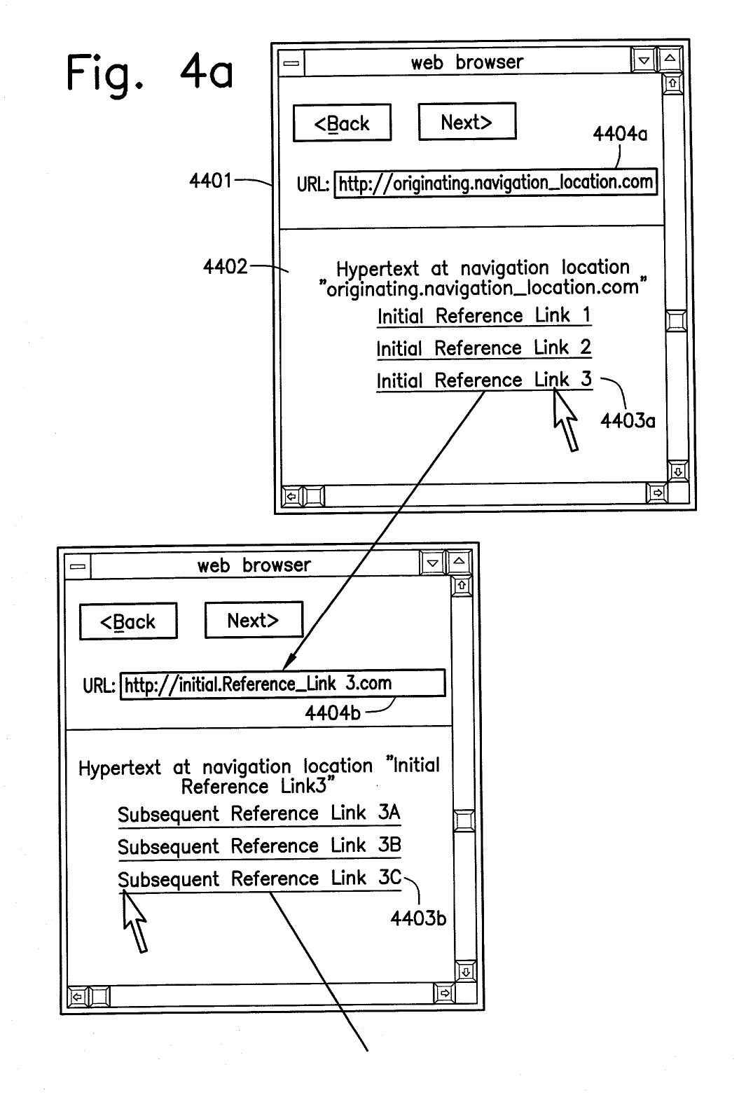

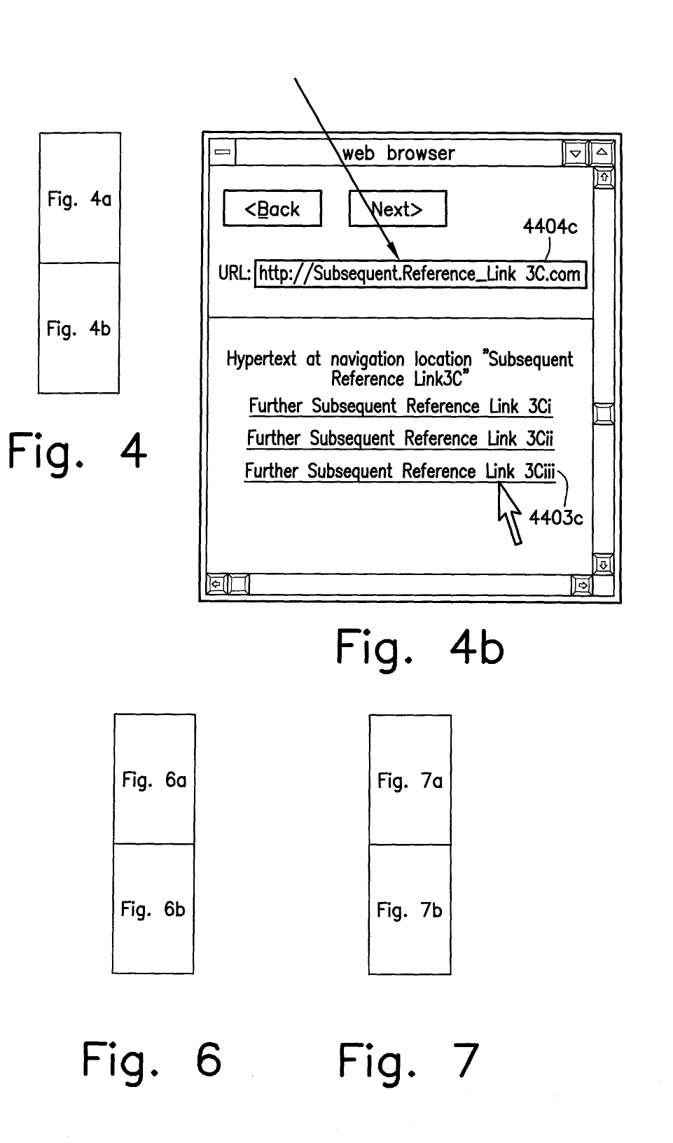

FIG. 4 shows web pages 4401 with hypertext 4402 and reference links 4403 at various navigation locations 4404. An originating navigation location 4404a references hypertext that may have initial reference links 4403a. These initial reference links are proximal links to the originating navigation location.

One may view hypertext at an initial reference navigation location 4404b by traversing an initial reference link. The subsequent reference links 4403b found in the hypertext found at the initial reference navigation location are also proximal links, however, they are one reference less proximal (i.e., one “hop” away) to the originating navigation location.

One may view hypertext at a subsequent reference navigation location 4404c by traversing a subsequent reference link. The further subsequent reference links 4403c found in the hypertext found at the subsequent reference navigation location are also proximal links, however, they are two references less proximal (i.e., two “hops” away) to the originating navigation location.

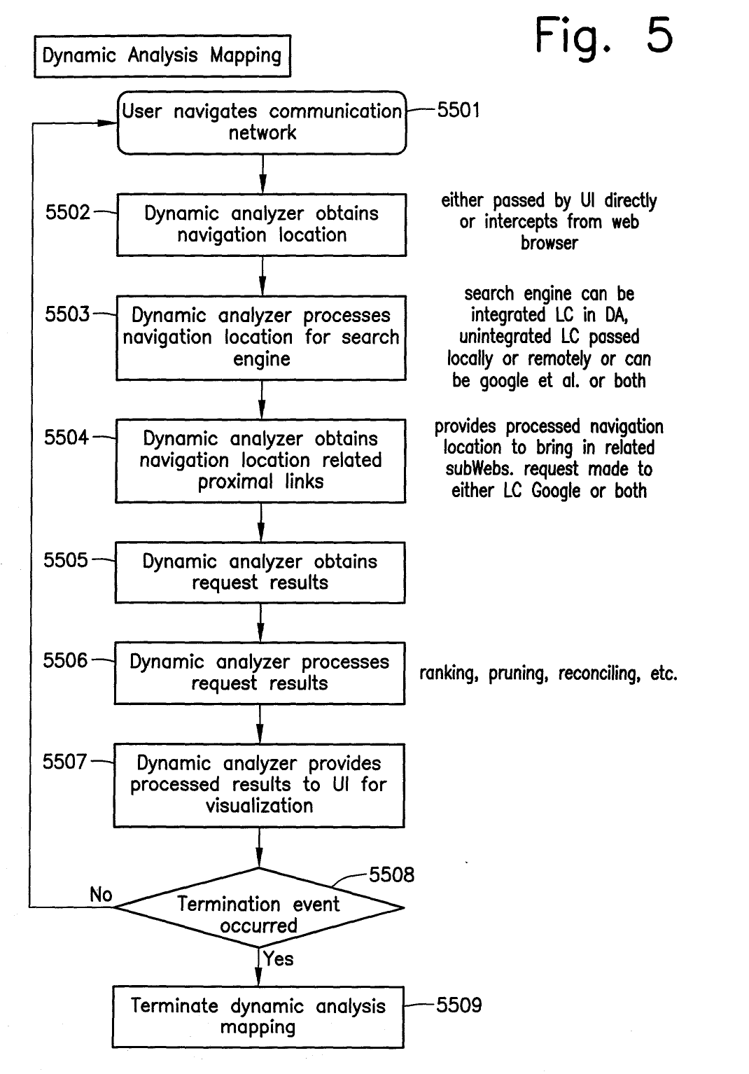

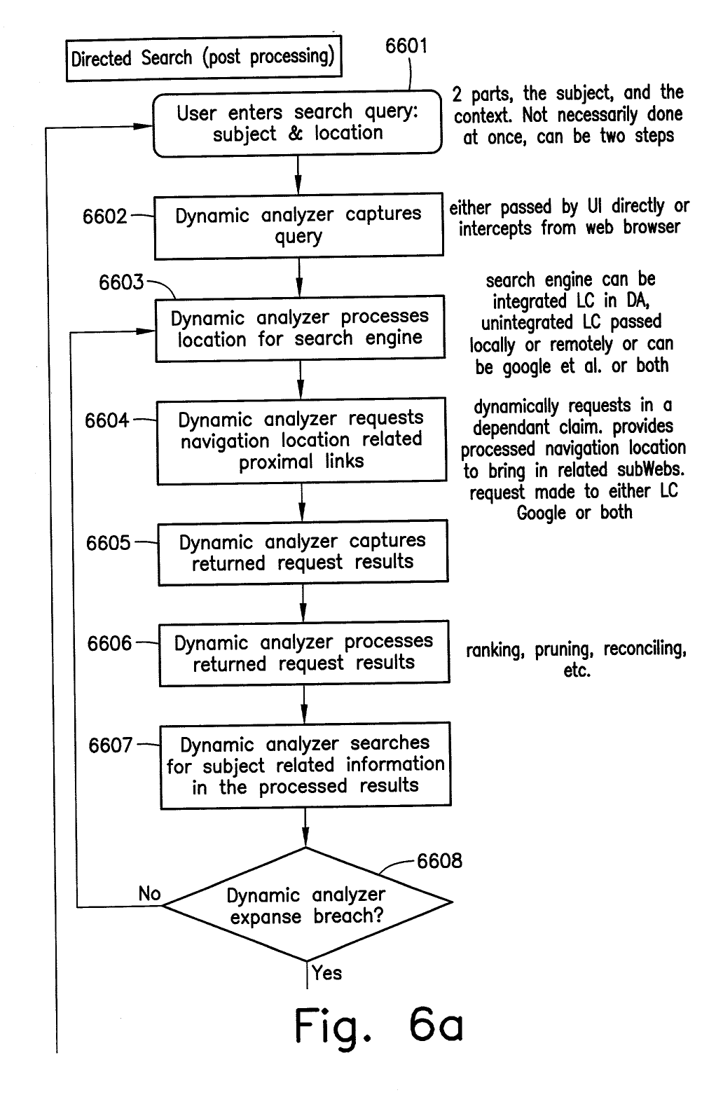

FIG. 5 outlines the production of dynamic analysis maps. Initially, a user, or even an automated system such as a web bot, navigates a communications network 5501, for example the Internet. Typically this is referred to as “surfing the Internet,” “surfing the net,” or simply “surfing.”

Web browsers and/or the like keep track of the navigation location they are visiting, and can provide this information to other facilities through various application program interfaces (API)s. The dynamic analyzer can thus obtain the current navigation location 5502 the user is visiting through a provided API; for example, Windows Internet Explorer allows this by examining the cache it maintains in a directory or by API. The dynamic analyzer may obtain the navigation location through: a provided API of a web browser, by having it entered directly into the dynamic analyzer, or through another program facility with an API that allows it access to or provides this navigation location.

Upon obtaining the navigation location, the dynamic analyzer processes the navigation location from the providing source into a format required by a web search engine 5503. This processing is often simple string and character manipulation formatting navigation location strings into a syntax required for any number of web search engines.

Once the navigation location has been provided, the dynamic analyzer can obtain (i.e., request) related proximal links for the specified navigation location 5504. This request can be made to any number of web search engines. The search engine may be integrated into the dynamic analyzer, or an external web search engine. Upon obtaining the request, the web search engine will perform a search and provide results. The results may be in the form of singular navigation locations, or a subweb. A subweb is a local neighborhood of connected and/or related sites and pages on the Web about a given navigation location.

The dynamic analyzer obtains the request results 5505 from the web search engine. If the web search engine is integrated into the dynamic analyzer, this may be accomplished through: variable passing, object instance variable communication, internal messaging, shared memory space, or the like. The preferable embodiment will depend on the context of system deployment; i.e., factors such as the capacity of the underlying hardware resources. If the web search engine is external to the data analyzer, capturing the obtained request results may be accomplished through: shared files, process pipes, API information passage, or the like. Again, the preferable embodiment will depend upon the context of system deployment.

Upon having obtained the request results, the dynamic analyzer will process the obtained results 5506. Many times the obtained results, particularly from monolithic web search engines, provided by the web search engine facility include unwanted or poor results: repeated navigation locations, inaccessible navigation locations (i.e., dead links), irrelevant navigation locations, and/or the like. The dynamic analyzer may prune irrelevant and inaccessible navigation locations, rank the results, and otherwise reconcile the results. Such pruning, ranking and reconciling may be accomplished using standard data-processing string, compare, sort techniques, and/or the like. The dynamic analyzer will also examine and rank media type content at the navigation location such as, but not limited to: size of textual information; number and size of pictures; the staleness of the links (i.e., the last time the links were updated showing that data may be dated and less relevant); number and size of media formats such as, but not limited to, MP3, AVI, and/or the like; and other types of the like. Such media format ranking may be determined by user preference or program preset. Furthermore, the data analyzer will process the results into a format appropriate for a particular user interface for visualization of the results.

Upon having processed the obtained request results, the dynamic analyzer provides the processed results to a user interface for visualization 5507. This processing is often simple string and character manipulation formatting navigation location strings into any required syntax.

After providing results to the user interface for visualization, the dynamic analyzer will examine to see if a termination event has occurred 5508. If a termination event has not occurred, the dynamic analyzer will again examine how the user navigates a communication network 5501, 5502. If a termination event has occurred, dynamic analysis mapping termination results 5509.

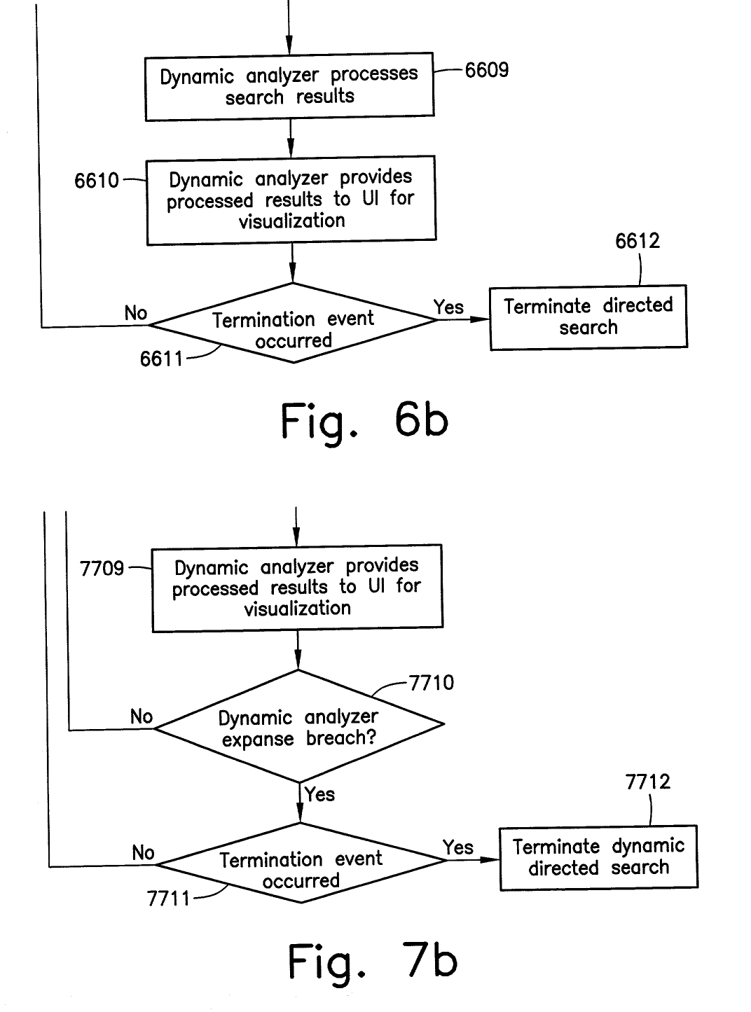

FIG. 6 outlines a directed search. Initially, a user, or even an automated system such as a web bot, provides a search query 6601. The search query includes, but is not limited to, parameters such as a search subject and a context. Currently, the preferable context is to provide a navigation location. The user may provide the search query to a facility in a user interface, in a hypertext form, or any other facility that can provide the query information to the dynamic analyzer.

The dynamic analyzer obtains the search query 6602. This query may be, but is not limited to being, passed by a user interface, user interface device, a web browser, and others of the like.

Upon obtaining the context, preferably in the form of a navigation location, the dynamic analyzer processes the navigation location from the providing source into a format required by a web search engine 6603. This processing is often simple string and character manipulation formatting navigation location strings into a syntax required by any number of web search engines.

Once the navigation location has been provided, the dynamic analyzer can obtain (i.e., request) related proximal links for the specified navigation location 6604. This request can be made to any number of web search engines. The search engine may be integrated into the dynamic analyzer, or an external web search engine. Upon obtaining the request, the web search engine will perform a search and provide results. The results may be in the form of singular navigation locations, or a subweb.

The dynamic analyzer obtains the request results 6605 from the web search engine. If the web search engine is integrated into the dynamic analyzer, this may be accomplished through: variable passing, object instance variable communication, internal messaging, shared memory space, or the like. The preferable embodiment will depend on the context of system deployment; i.e., factors such as the capacity of the underlying hardware resources. If the web search engine is external to the data analyzer, capturing the obtained request results may be accomplished through: shared files, process pipes, API information passage, or the like. Again, the preferable embodiment will depend upon the context of system deployment.

Upon having obtained the request results, the dynamic analyzer will process the obtained request results 6606. Many times the search results, particularly from monolithic web search engines, provided by the web search engine facility include unwanted or poor results such as: repeated navigation locations, inaccessible navigation locations (i.e., dead links), irrelevant navigation locations, irrelevant subject matter, and/or the like. The dynamic analyzer may prune irrelevant and inaccessible navigation locations, rank the results, and otherwise reconcile the results. Such pruning, ranking and reconciling may be accomplished using standard data-processing string, compare, sort techniques, and/or the like. The dynamic analyzer will also examine and rank media type content at the navigation location such as, but not limited to: size of textual information; number and size of pictures; number of links referencing the information; the staleness of the links (i.e., the last time the links were updated showing that data may be dated and less relevant); number and size of media formats such as, but not limited to, MP3, AVI, and/or the like; and other types of the like. Such media format ranking may be determined by user preference or program preset. Furthermore, the data analyzer will process the results into a format appropriate for a particular user interface for visualization of the results.

Upon having obtained processed request results, or integrated into the processing of the obtained request results, the dynamic analyzer obtains subject related information in the processed results 6607. Based on the subject matter provided by the user in the search query, the dynamic analyzer ranks the subject matter of the processed results. Such ranking may be accomplished using standard data-processing string, compare, sort techniques, and/or the like. Preferably techniques like a modified shark search or fish search are employed ranking the results' relevancy. The modified search techniques add the novel ability to also examine and rank media type content at the navigation location such as, but not limited to: size of textual information; number and size of pictures; number of links referencing the information; the staleness of the links (i.e., the last time the links were updated showing that data may be dated and less relevant); number and size of media formats such as, but not limited to, MP3, AVI, and/or the like; and other types of the like. Such media format ranking may be determined by user preference or program preset.

After ranking the previous processed request results, the dynamic analyzer may further refine its results by recurrence. The dynamic analyzer can check to see if a search expanse breach has occurred 6608, if not, then the dynamic analyzer may take the ranked processed request results, which preferably have associated navigation locations, arid provides the ranked processed request results to the search engine navigation location processor 6603. A search expanse breach will occur based on several factors that may be: preset, or provided by a user or system. A search expanse breach will occur when the search has taken longer than a set amount of time, or has recurred too many times (either in breadth or depth along a graph of subwebs).

If a search expanse breach does occur, the dynamic analyzer will process the latest search results 6609. Each recurrence, or iteration, of the aforementioned directed search will provide additional search results. These search results may be maintained in any number of standard data processing data structures such as lists, arrays, stacks, databases, and/or the like. Preferably a list will maintain the results. Repeated iterations may produce duplicate results, and a range of results of varying relevancy. The final search results are processed removing duplicates and ranking the results based on subject relevancy. Furthermore, the data analyzer will process the results into a format appropriate for a particular output target, e.g., a file, a user interface for visualization of the results, and/or the like.

Upon having processed the obtained final search results, the dynamic analyzer provides the results to a user interface for visualization 6610. This processing is often simple string and character manipulation formatting navigation location strings into any required syntax.

After providing results to the user interface for visualization, the dynamic analyzer will examine to see if a termination event has occurred 6611. If a termination event has not occurred, the dynamic analyzer will again examine users search query 6601, 6602. If a termination event has occurred, directed search termination results 6612.

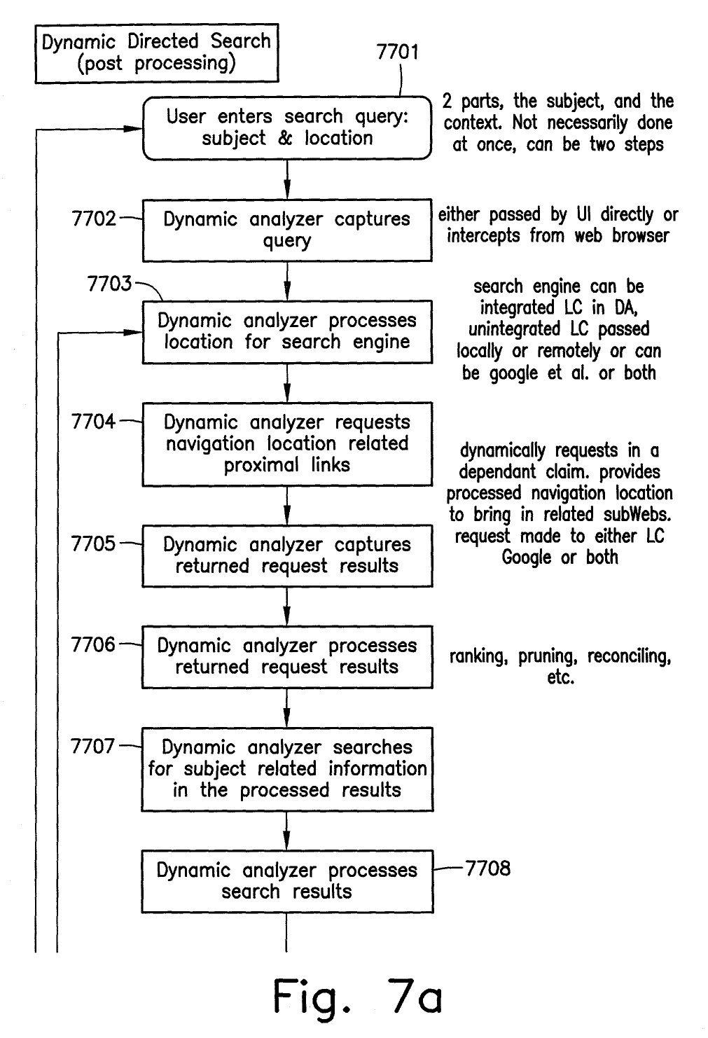

FIG. 7 outlines a dynamic directed search. It is the same as the directed search of FIG. 6 except: processed search results 6609 and FIG. 7 analogue 7708, and provision of results to the user interface 6610, 7709 occur before the search expanse breach check 6608, 7710; the search expanse breach check 7710 now occurs after the provision of results to the user interface 7709. Also, now, after the search expanse breach, the termination event check 7711 occurs. This modification allows for dynamic updating and display of search results.

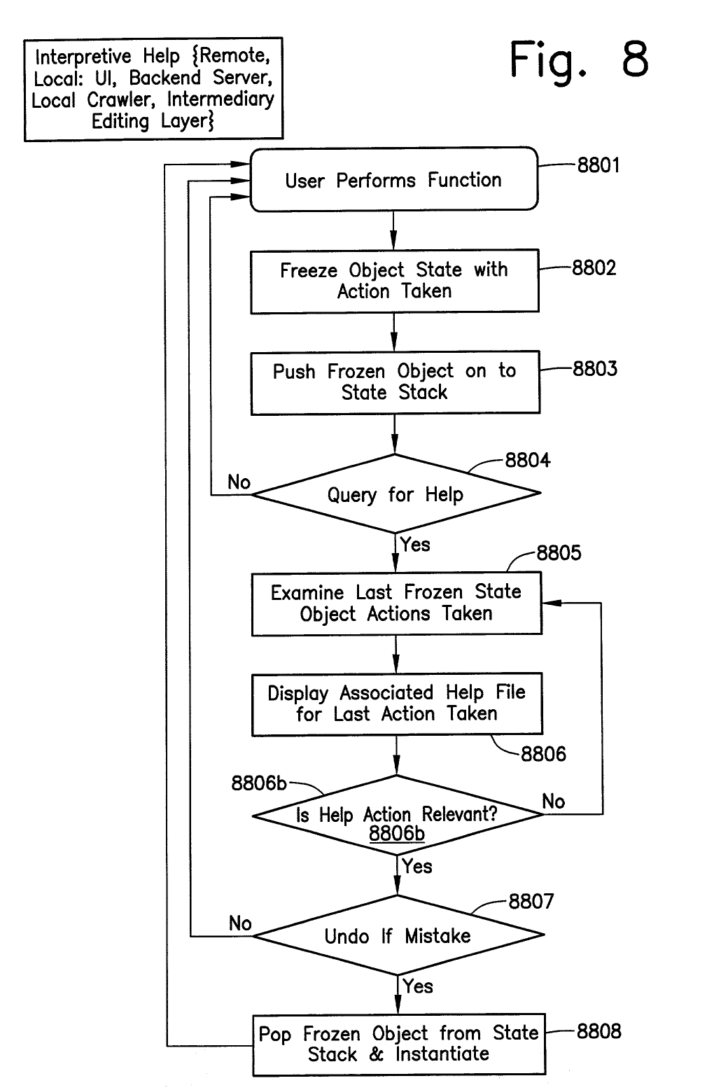

FIG. 8 outlines an interpretive help facility. Initially, a user performs some action 8801 where an interpretive help facility is provided. The current environment state is saved. The environment maybe saved in any number of common ways with standard data processing techniques such as, but not limited to: a file, composite data structures, arrays, stacks, and/or the like. The preferred form is to save (i.e., freeze) an object state as provided in many object-oriented languages such as Java, Smalltalk, C++, Objective C, and/or the like; the preferred implementation language will depend upon the deployment environment. In addition to the environment state, the last action taken by the user may be saved 8802.

After freezing the action object state, preferably the action object state is pushed onto a stack of such action object states 8803. However, the action object states need not be saved onto a stack, and may be collected using other standard data structure types.

After pushing the previous action object state onto the state stack, the interpretive help facility will check if the user has requested help 8804. If the user has not made a request for help, the interpretive help facility will continue to archive action object help states 8801, 8802.

If the user has requested help, the interpretive help system will examine the next frozen action object states 8805. The interpretive help facility will thaw and/or examine the object states and determine the actions taken by the user and map the action to an index of help topics using standard data processing comparison techniques such as, but not limited to string compares. In one non limiting example, when thawing a frozen object state, that state's method last called method string is compared to a help index for a match. This thawing process can be recurred backwards in time from the latest object states backward in time to the earliest. In one embodiment, the recursion is limited to the last few states. The frozen objects may be stored in various data structures. Preferred data structure embodiments will depend on the availability of underlying resources, such as processing power, memory, and/or the like. In one embodiment, the frozen objects may be saved in a linked list stack, where traversal through the stack is possible without actually popping items off the stack. As actions are taken, they would be added to the stack.

After the proper help action subject has been selected, the interpretive help facility will request and display the appropriate help information 8806. The user may then determine if the provided help information 8806 is relevant 8806b. In one embodiment, the user would be prompted with a “Yes” or “No” button prompts asking the user if the displayed help information is relevant. If the information is not relevant, then the interpretive help facility may recur further through the stack of frozen object states and examine the next frozen object state 8805. In an alternative embodiment, a list may be created for the user to make selections to go to help information topics in a random access fashion rather than recurring through the stack. In such a list embodiment, a list display widget would be populated with the actions saved in the frozen object state stack representing the user's last actions. Selecting any of the action items would take the user to help matching the action.

If the displayed help information is relevant 8806b, the help information displayed to the user will allow the user to undo his last action 8807. After the user reads the appropriate help pages, the interpretive help facility may provide the user with a prompt asking if based on the help information that the user believes he or she made a mistake, and if so, will allow the user to undo their mistake by engaging a provided “mistake” button and/or “undo” command. If the user does not wish to undo, then the interpretive help facility will recur and continue to track user actions 8801, 8802.

However, if the user wishes to undo her previous action, the interactive help system can pop the last action object state from the state stack and instantiate that state using common object oriented data processing techniques for undo systems 8808. After the reinstantiation of the previous object state, the interpretive help facility will recur and continue to track user actions 8801, 8802. It's important to note that an undo functionality does not have to be a part of the interpretive help facility and so after the provision of help information 8806, the interpretive help facility may recur and continue to track user actions 8801, 8802, but it is preferable to provide the undo facility.

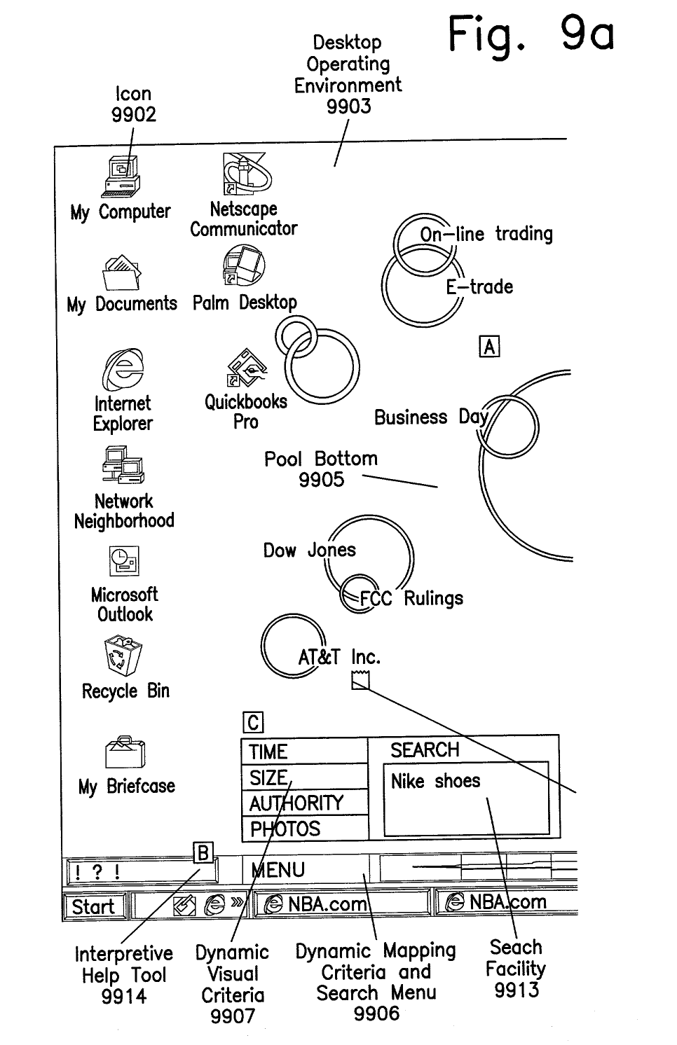

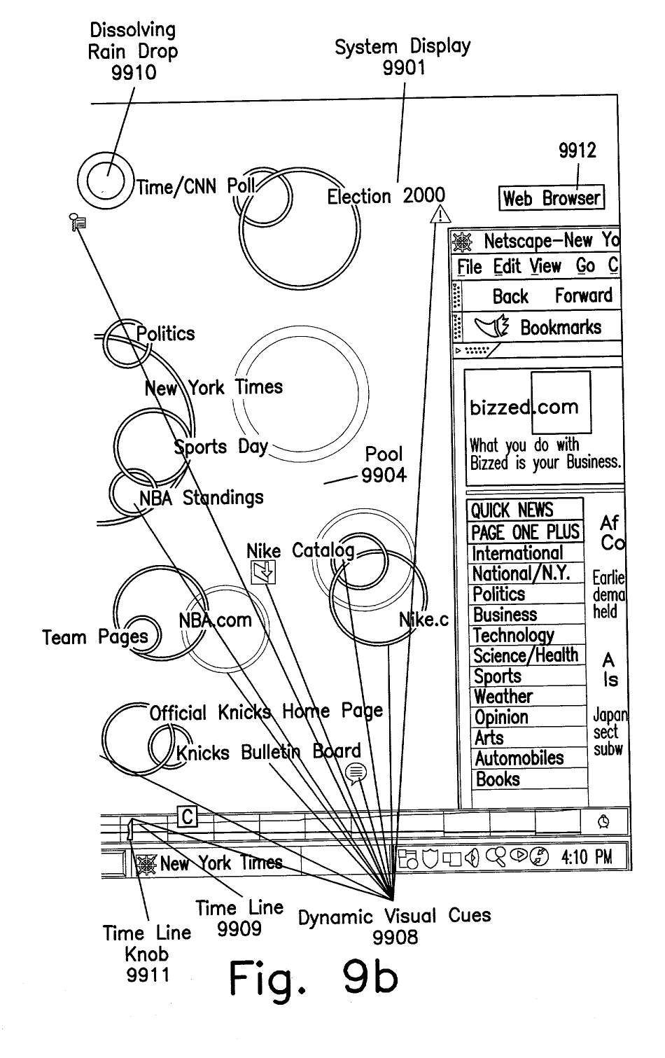

FIG. 9 illustrates a system display 9901 presented to a user. The system display shows a traditional graphics user interface employing a desktop metaphor containing user selectable icons 9902 and/or the like; i.e., a desktop operating environment 9903. Preferably, the desktop layer is transformed into a temporal pool 9904. This transformation may be operating system dependant. It may be employed by: accessing provided desktop operating environment APIs such as those offered by the Backgrounds preference facilities of Microsoft Windows 98; by patching the operating system; or like techniques. Alternatively, or in conjunction with the desktop pool, pools maybe implemented in separate windows, in subviews of a window, or the like. The pool also has a pool bottom 9905. The pool bottom may display advertising banners, movies, photos, and other media format types. The pool bottom contents may also be updated in time based on a user or system specified period. An effect may be applied over the pool bottom contents giving it the appearance of liquid visual distortion using standard fishbowl and diffusion transformation techniques, the likes of which may be seen in applications such as Adobe Photoshop. Although the discussion of the temporal quantum interface will be framed in terms of a liquid pool throughout the disclosure, it is to be understood variations on the theme may be implemented, such as by employing a snowflake like metaphor, and/or the like. The raindrops may be represented as squares and/or other arbitrary shapes. The basics of the interface require a display area (the pool), an the ability to view complex (directed graph) information organized in time in an uncluttered manner one time quantum at a time, and allowing the user to access any particular time quantum at random.

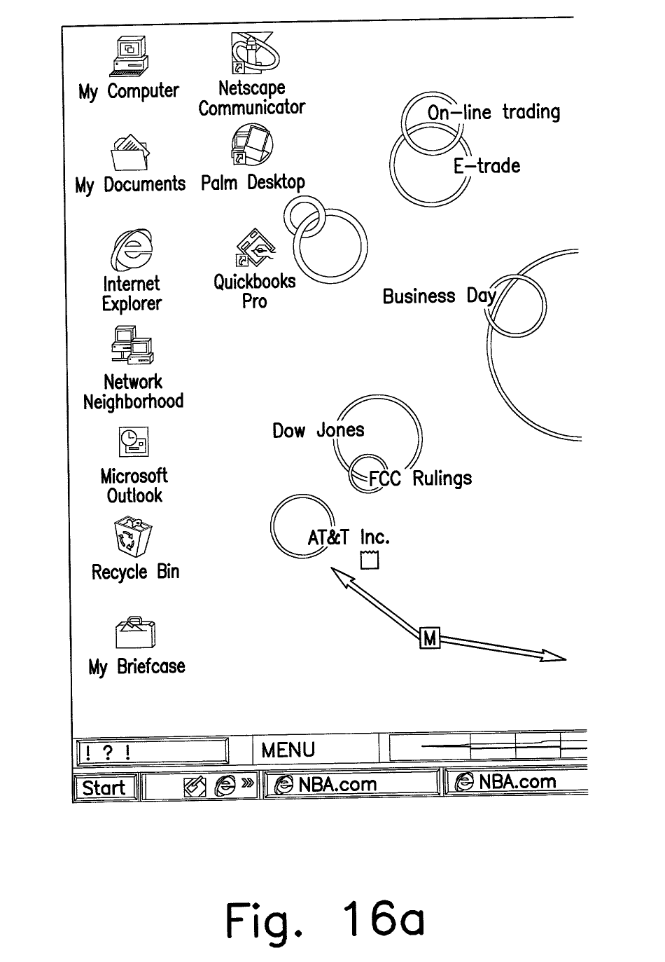

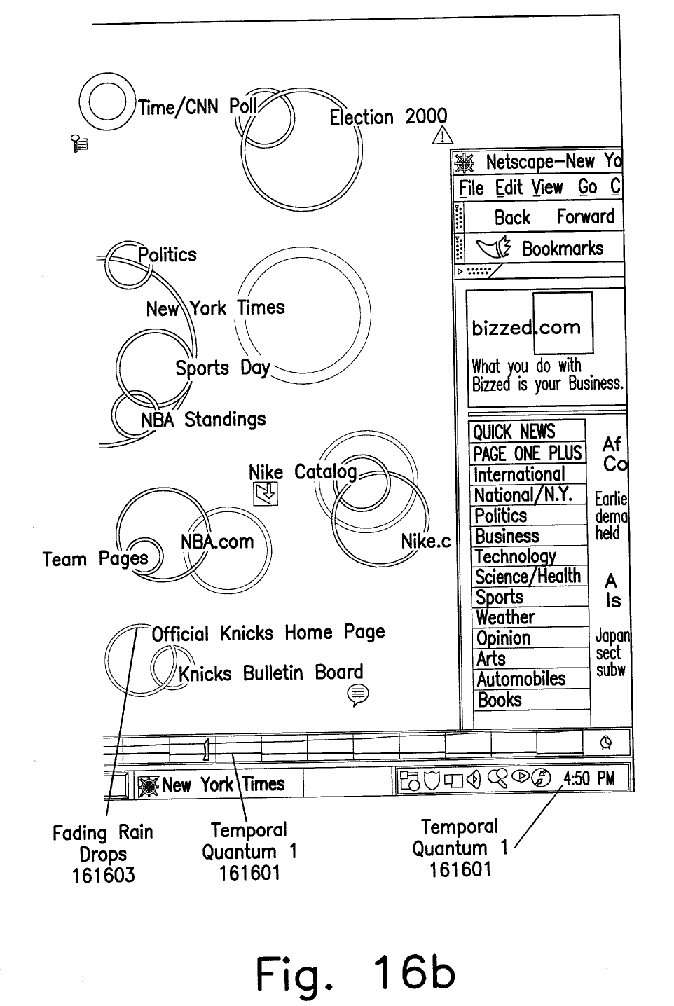

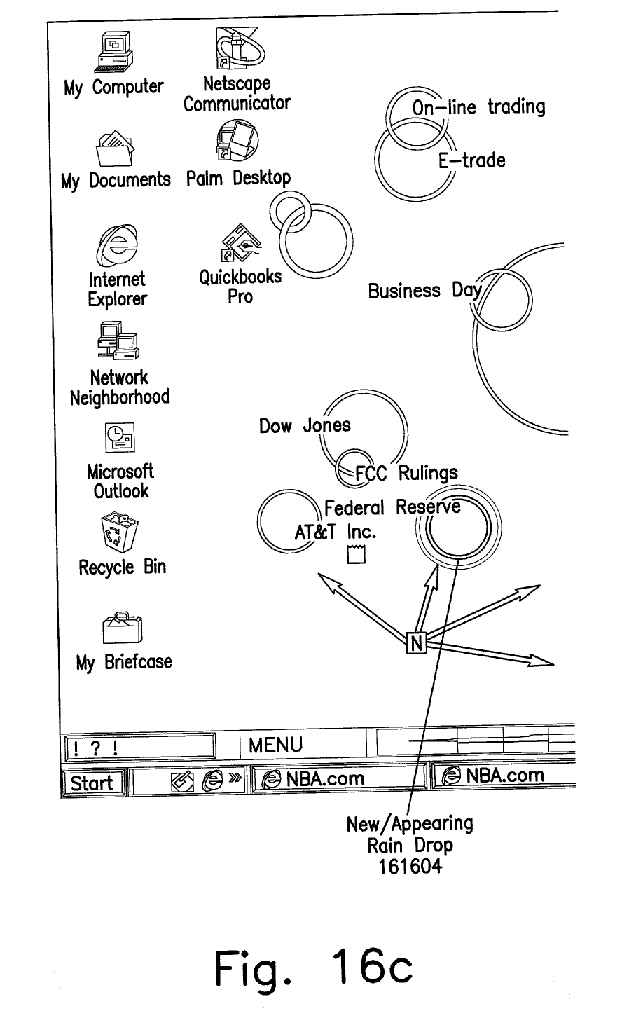

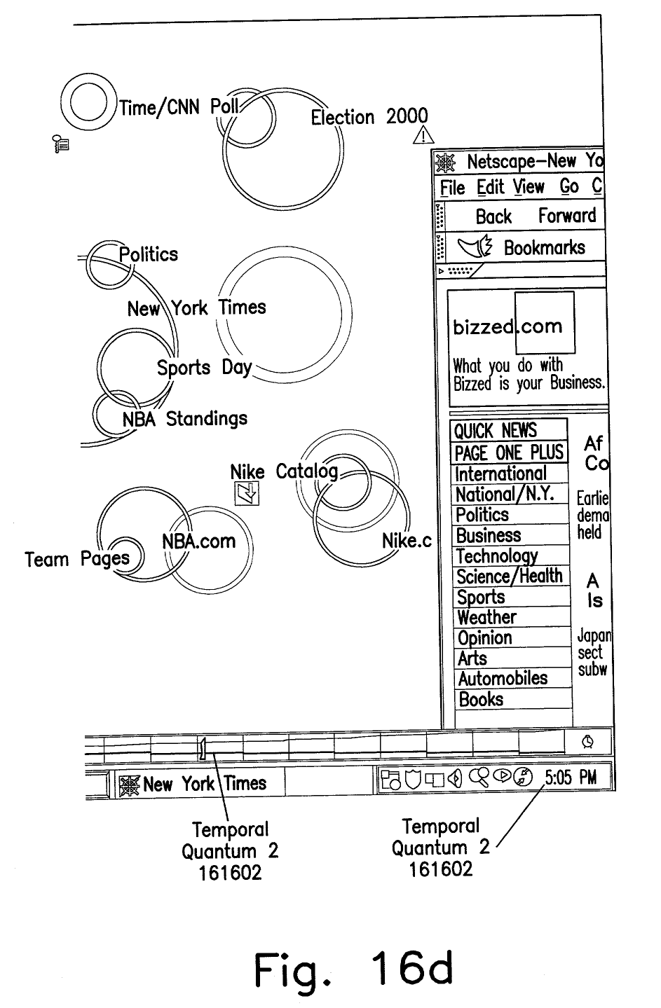

Into any pool of water, information rains. The rain falls from clouds. Clouds form when information is provided from sources such as, but not limited to, a data analyzer. As clouds form, they fill with crystals. Crystals represent navigation locations that have yet to condense and fall into the pool. The data crystals preferably contain information such as: navigation location, subject, media type information, and/or the like; although less information may be provided, the more information available for each crystal, the more the resulting visualization will be informative. Preferably, the clouds and crystals are implemented as data structures and are invisible to the user. The clouds may be implemented employing any number of standard data processing data structures such as lists, arrays, and/or the like, but the preferable data structure form employs a hashtable. A temporal quantum is the difference in time between temporal quantum 2 161602 of FIG. 16 and temporal quantum 1 161601 of FIG. 16. A temporal quantum is used for graphical state updates and is set either by user preference or system preset. The temporal quantum determines the rate at which crystals condense into raindrops and fall into a pool.

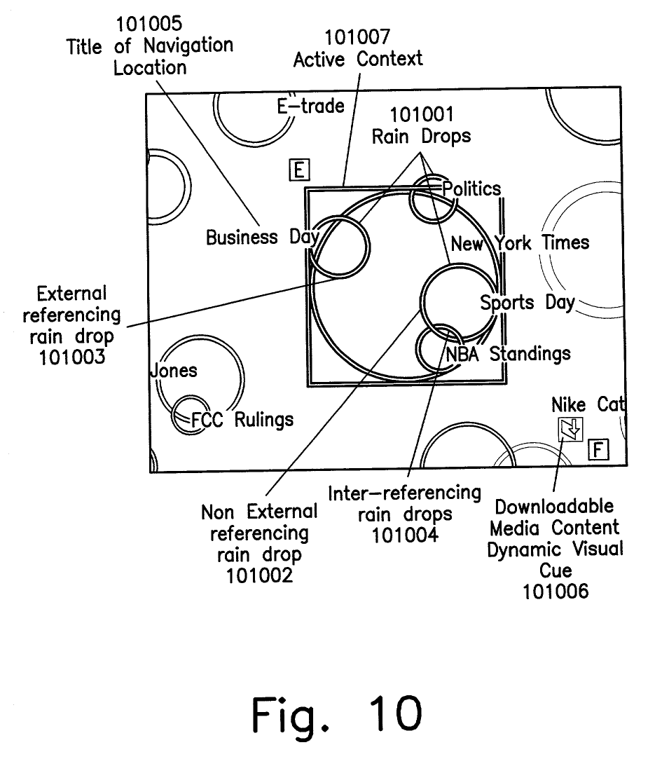

Once a temporal quantum has transpired, a crystal will condense and fall into the pool disturbing the water, thus creating raindrops 101001 of FIG. 10. The ordering of which crystals from an information cloud will form into raindrops may be determined by the ordering of data in the information cloud data structure. In alternative embodiments, the order of raindrop formation may be varied based on user preferences, e.g., media formats are set to form faster than text data (i.e., media being heavier and/or larger data). The raindrops disturb the water similarly to how such natural phenomena occurs, thus, causing ripples. The visual rendering of such an effect is widely known in data processing and may be achieved by using techniques such as fish bowl and diffusion transformations, the likes of which may be seen in popular applications such as Adobe Photoshop.

The raindrops fall in groups based on the relationship of the underlying data they represent. Thus, for example, if a data analyzer provides a subweb parent page (i.e., the web page referring to other related web pages) and this information is crystallized in a cloud and falls into a pool, the main ring will represent the subweb parent page. The size of a raindrop will be determined by any user or system specified criteria such as, but not limited to: size of the document, number of related links, number of photos, staleness of links, media content type, subject relevancy ranking, or the like. These criteria may be accessed and modified by the user through a dynamic mapping and search criteria menu 9906 or like facility, which will show the user current dynamic visual criteria 9907, and upon selection allow users to modify the visualization by setting parameters in a dialogue box or like facility. The preferable default is for the raindrop size to be related to the number of additional references contained within.

The color of a raindrop will be determined by any of the aforementioned user or system specified criteria. The preferable default is for color to vary with the size of the content to be accessed: e.g., red raindrops represent large documents that might take longer to access, yellow raindrops represent smaller documents, and green raindrops may represent small and fast loading documents. Any number of color to criteria mappings may be employed, however, the preferred default is to limit the granularity of the mappings to the three aforementioned colors. Similarly, levels of transparency, and thickness of the raindrop rings may be used to represent any of the aforementioned criteria; however, this is not preferable by default as the visualization may become more complicated and cluttered.

Raindrops that fall or appear in proximity to one another represent related information to the user. Raindrops representing related or referenced information, for example the reference links of subweb parent, that fall completely within another raindrop represent a related raindrop with no external references 101002 of FIG. 10 pointing to sources outside the domain of the subweb parent. Raindrops that intersect partially inside its parent raindrop, and partially outside, represent a related raindrop with external references 101003 of FIG. 10 pointing to sources outside the domain of the related raindrop's parent raindrop and with non external references pointing to sources inside the domain. Raindrops that touch only the outside of a parent raindrop and are otherwise outside the parent raindrop represent a related raindrop with substantially all external references pointing to sources outside the domain. Raindrops that do not touch or intersect are not related. Raindrops that have the same raindrop parent and that reference one another will intersect to show the inter-referencing 101004 of FIG. 10. Only the most relevant raindrop references will be displayed about a parent raindrop by default. It is possible, though not preferable, to have additional detail displayed, increasing the number of raindrops about a parent raindrop. Raindrops within a parent may further represent their own references in like fashion becoming sub-parents themselves. Subsequent raindrops related to their sub-parents will appear and may appear to grow in towards the center of the original parent raindrop, or outwards from the original parent based on user preference or system preset. However, it is not preferable to show such recursion as the display may become cluttered.

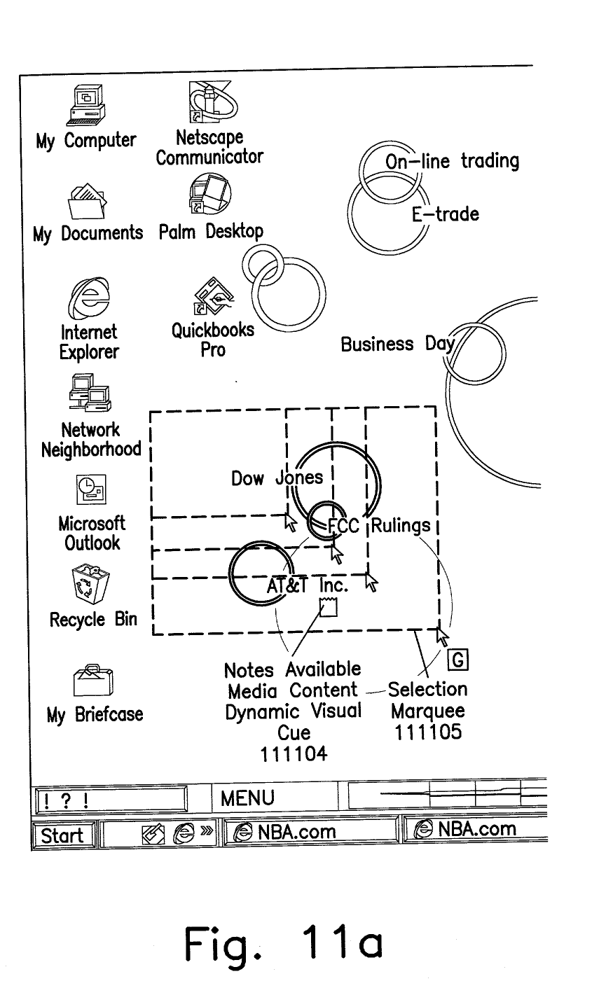

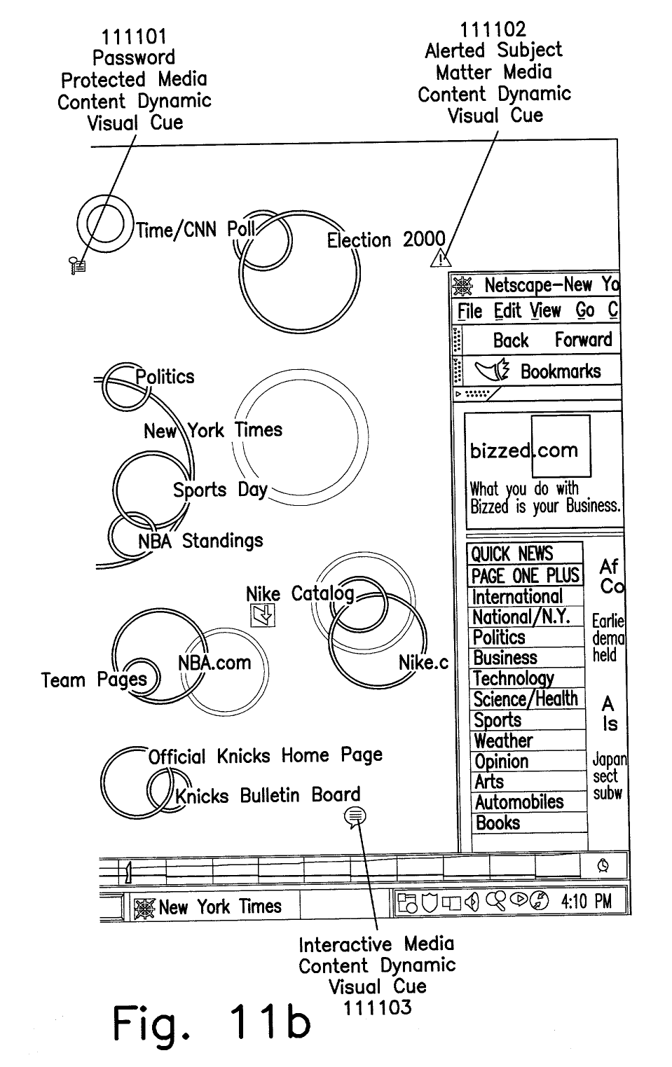

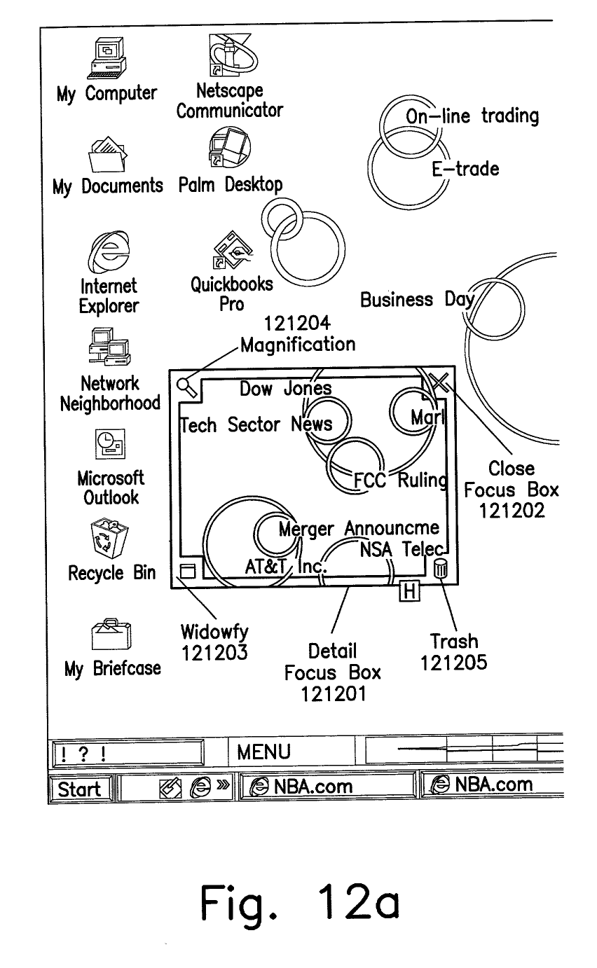

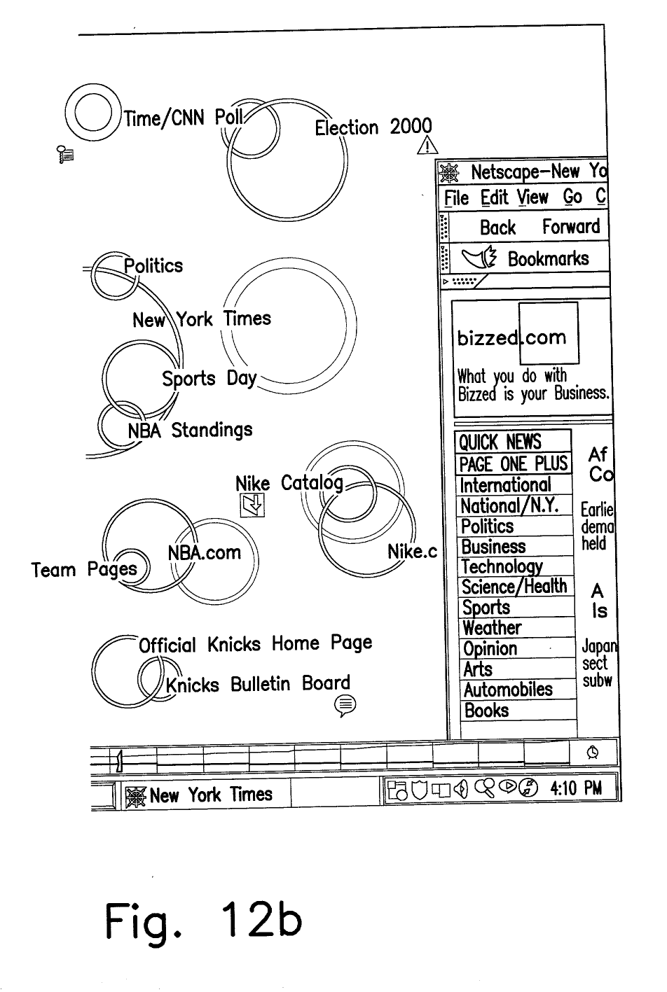

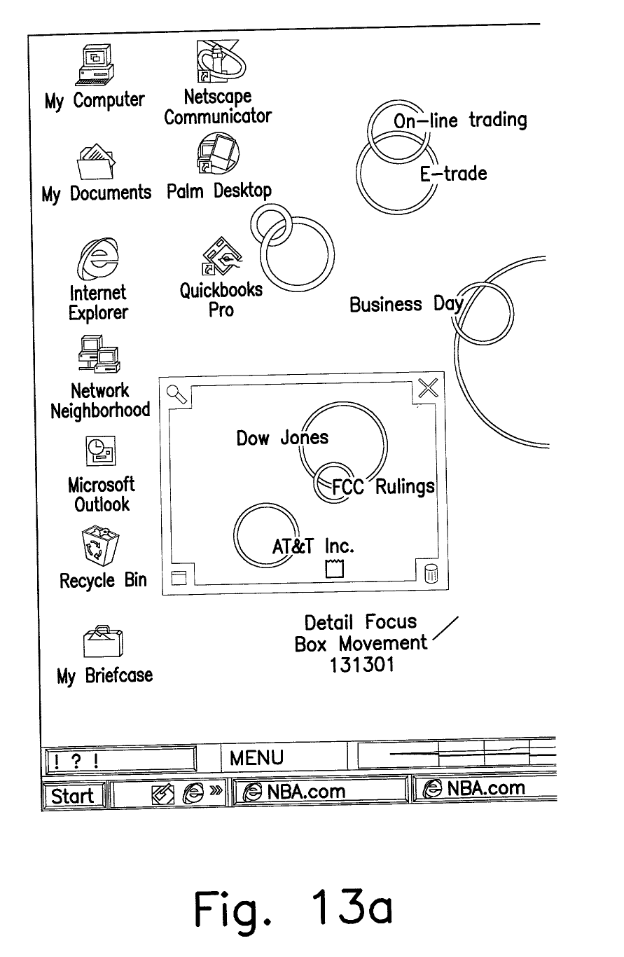

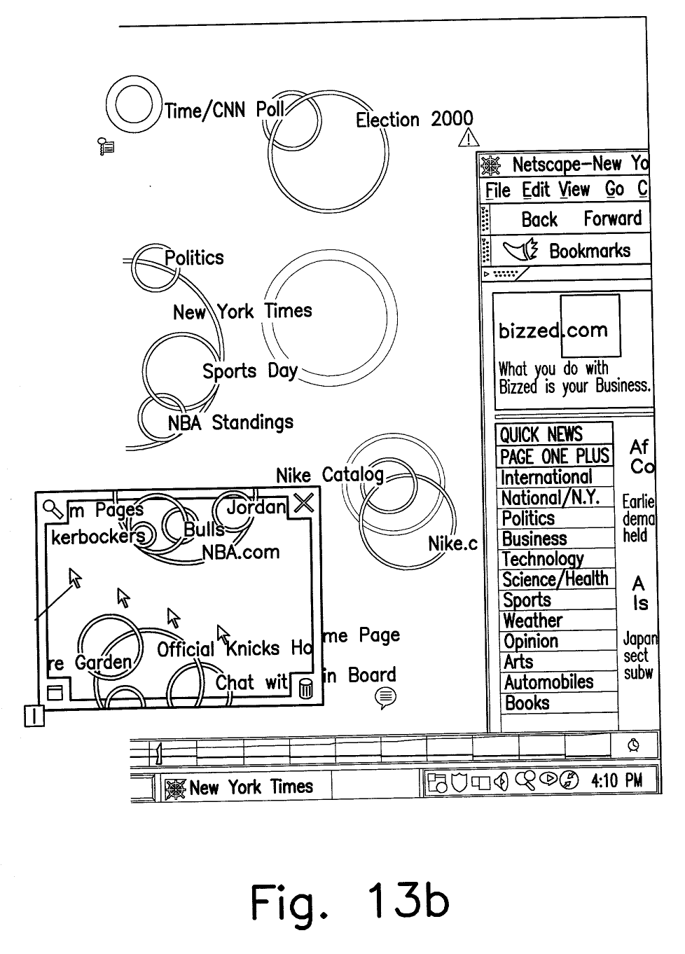

When raindrops form they are preferably labeled with a title from the data that the raindrop represents, usually a navigation location title 101005 of FIG. 10. When a user moves a pointing device over a title of a navigation location it will grow in size and show additional detail. Also, if the liquid temporal user interface is provided with information that the raindrop should reflect other media types it can provide alternative and/or complementary dynamic visual cues, preferably as small icon representations, 9908 such as, but not limited to: downloadable media content 101006 of FIG. 10, which represents that content is available for downloading; password protected media 111101 of FIG. 11, which represents content requiring a password for access; alerted subject matter media 111102 of FIG. 11, which represents a content that may not be appropriate (e.g., the likes of which may be flagged by facilities such as NetNanny, et al.); interactive media content 111103 of FIG. 11, which represents content that is dynamic in nature like live stream feeds, chat rooms, discussion boards, and/or the like; and notes available media content 111104 of FIG. 11, which represents content that has annotated notes available.

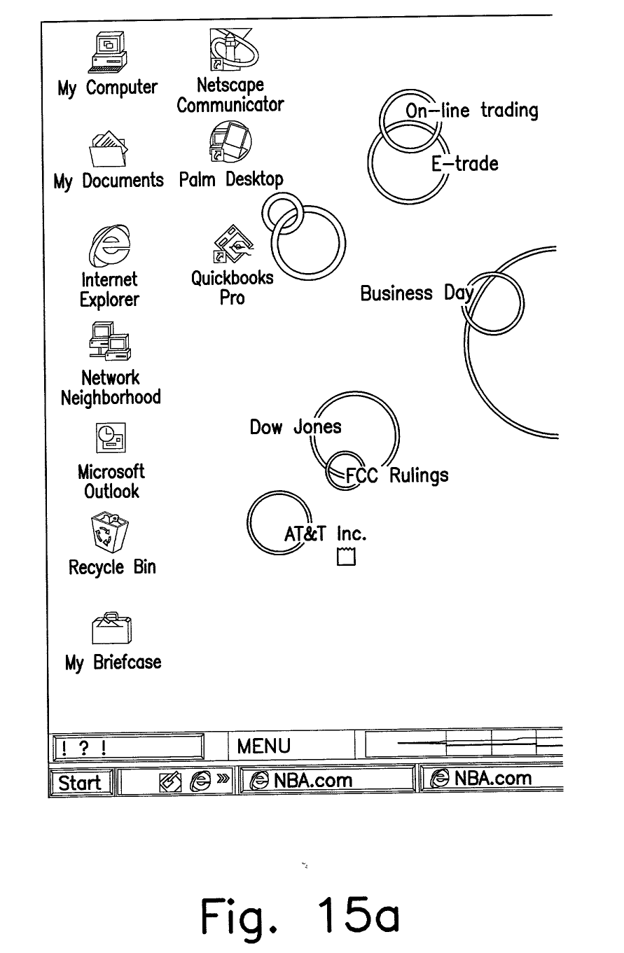

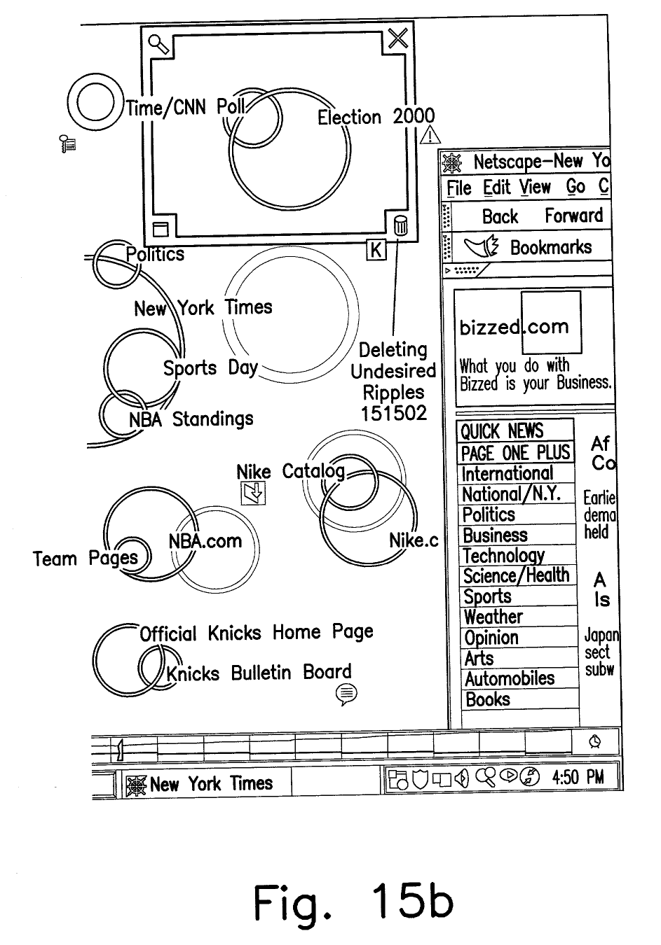

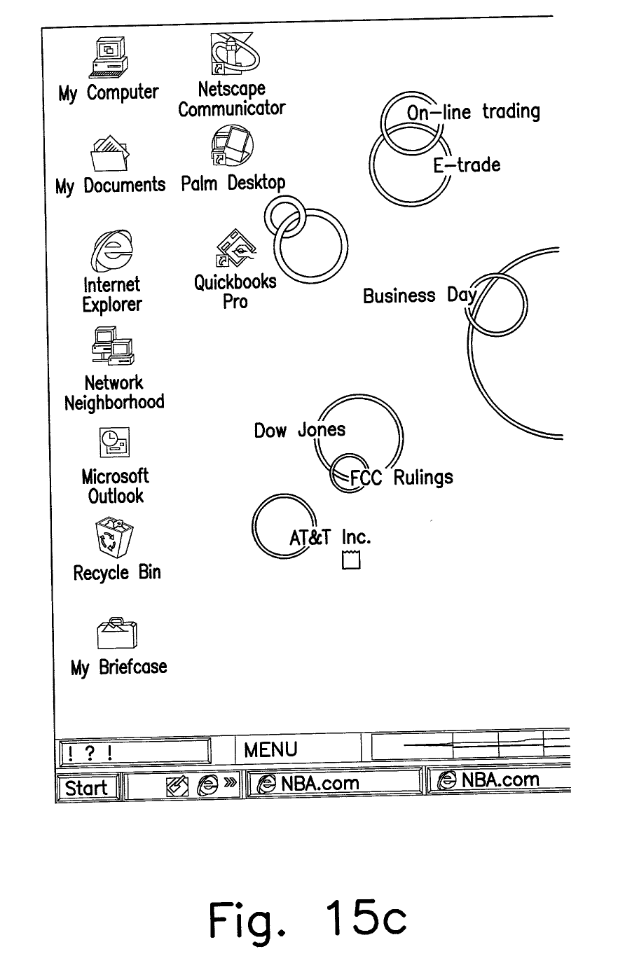

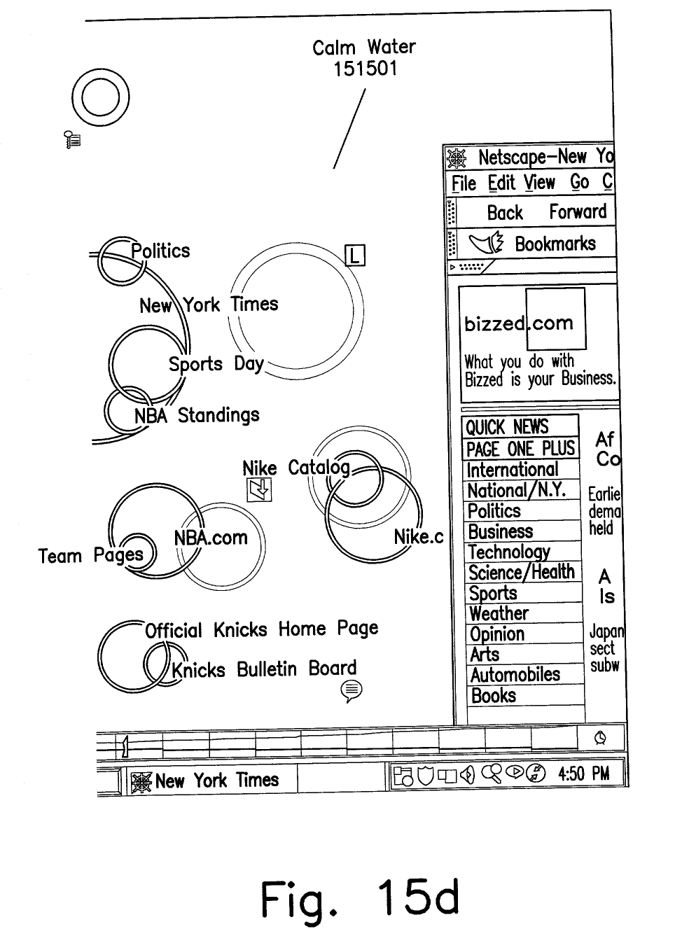

The raindrops dissolve 9910 with time and the water calms 151501 as in FIG. 15 until new raindrops appear 161604 as in FIG. 16 at the next temporal quantum. The raindrops will dissolve if the user does not interact with it or the web page underlying it. The rate of disappearance is predicated on how frequently the user interacts with them. The time line facility 9909 allows a user to go back and forth through the time of the data rain storm by selecting and manipulating the time line knob 9911. Manipulating the time line knob will cause the pool to churn and change its representation to the appropriate state and will cause raindrops to fade 161603 of FIG. 16 and form 161604 of FIG. 16.

At any given time, the user may select a raindrop, usually by clicking the ring with a pointing device. Once a raindrop is selected, the liquid temporal user interface will provide a web browser 9912 with a new navigation location to view. A box will highlight the active context 101007 of FIG. 10 representing that the highlighted raindrop(s) are currently being viewed in the web browser. The appropriate set of raindrops will be highlighted as the active context either when the user selects them within the liquid temporal user interface, or whilst the liquid temporal user interface is updated by a dynamic analysis mapping, directed searches, or the like; i.e., following the actions of the web browser or a search facility 9913.

A search selection facility may be provided, although not required, into which search subjects and other search criteria may be entered. These search query parameters along with the navigation location of the active context are provided to facilities such as, but not limited to: directed searches and dynamic directed searches. A search selection facility may be accessed via a menu, a button, a dialogue box, and/or the like.

Also, an interpretive help tool 9914 may be provided, although not required. Selecting the interpretive help tool will engage an integrated interpretive help facility providing it with an active context state.

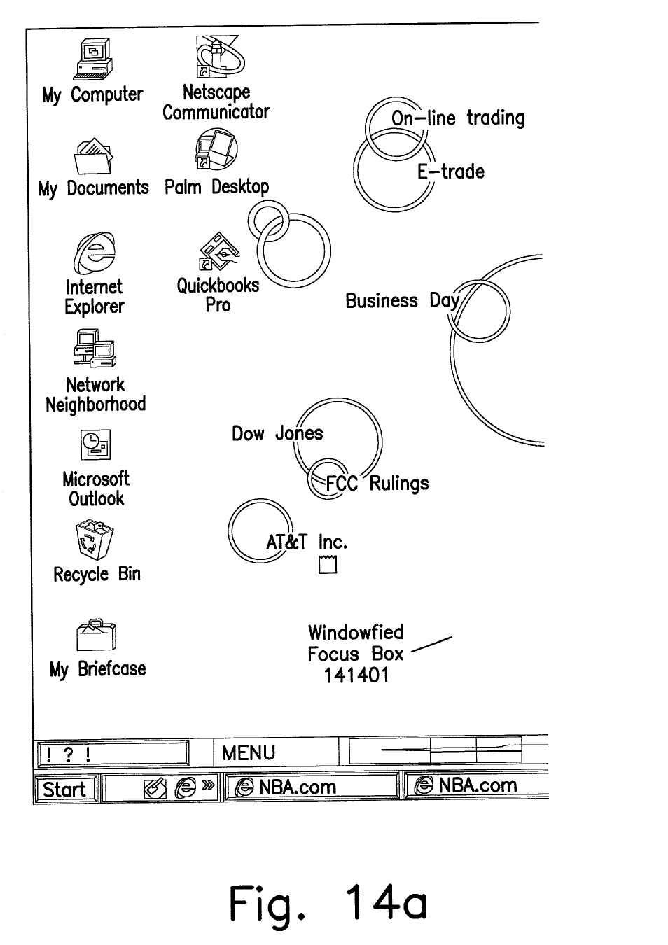

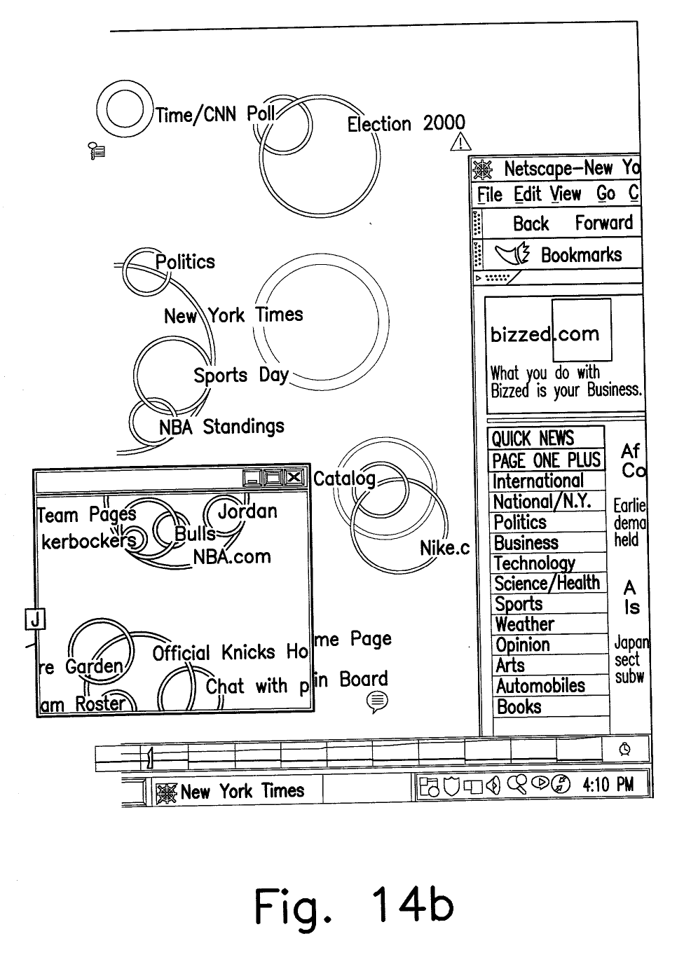

In FIG. 11 a user is extending a selection marquee about a set of raindrops that are of interest. In FIG. 12, after making the selection with the marquee, a detail focus box appears about the selection 121201. The detail focus box may be closed by selecting the close box 121202, windowfied by selecting the windowfy box 121203, semantically magnified (in or out) by selecting the magnification box 121204, or the contents within the detail focus box may be eliminated by selecting the trash box 121205. The creation of a detail focus box automatically increases the level of semantic detail shown within its borders as can be seen by the transformation of the contents within the selection marquee in FIG. 11 and the resulting more detailed view within the detail focus box in FIG. 12. The increased level of semantic detail can be provided by a dynamic analyzer recurring and semantically increasing the level of detail shown. FIG. 13 illustrates that a user may move a detail focus box about the screen and that any raindrops it covers will increase in the amount of semantic detail shown 131301.

FIG. 14 shows a windowfied view of a pool 141401. A user may scroll inside the windowfied view, or simply use it for ease of access. Windowfied views may be saved in a subweb bookmark facility by engaging a save key. Also, elements may be dragged and dropped into and out from a windowfied view. FIG. 15 shows that selecting the trash box in a detail focus box 151502 results in the pool water being calmed 151501. The pool underlying the detail focus box is calmed, i.e., the raindrops in the detail focus box are deleted.

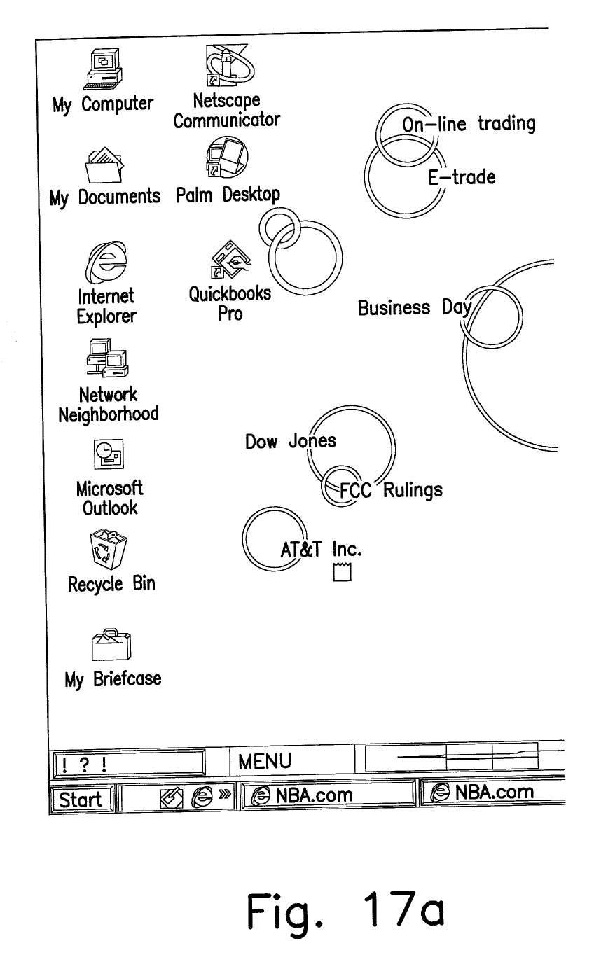

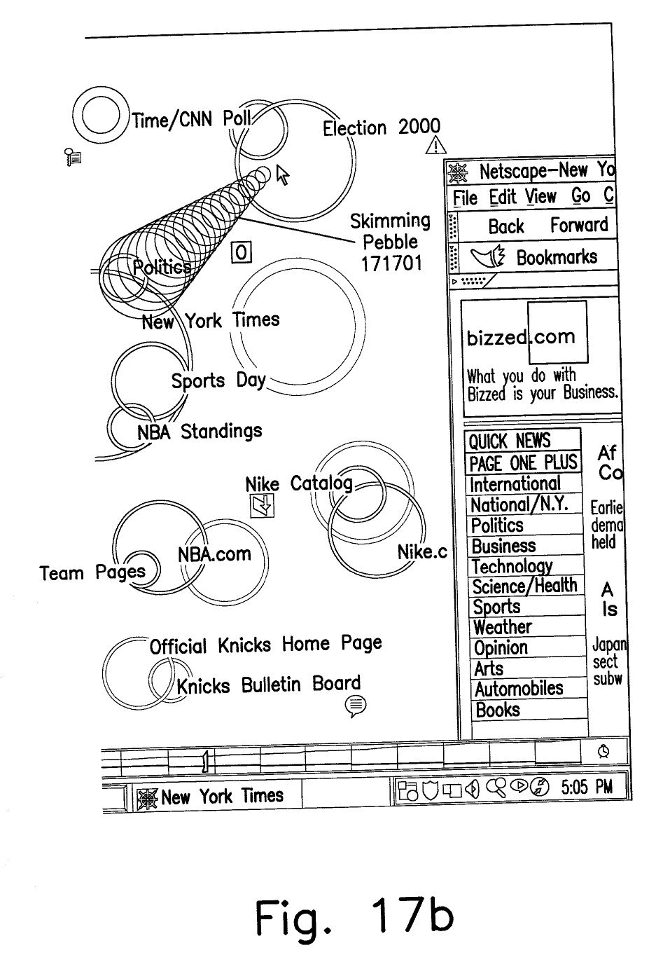

FIG. 17 shows a skimming a pebble 171701. A user can skim a pebble, preferably, by clicking and dragging over an area in the pool. The display will show a rippling, modeled after the natural phenomena, until the user stops dragging; i.e., until the user stops the selection or skimming. Raindrops that the user skims pebbles over will not dissolve and will remain in view. The liquid temporal user interface can then inform a data analyzer or web page to cache the web pages represented by the skimmed raindrops so when a user subsequently selects a skimmed raindrop, the web browser will display the referenced information more quickly.

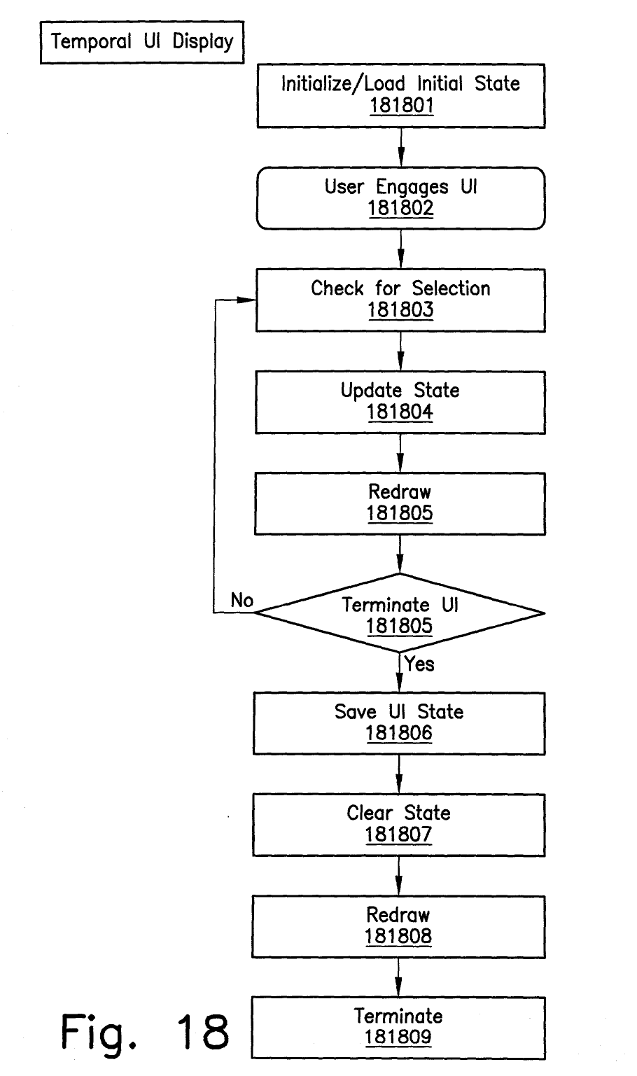

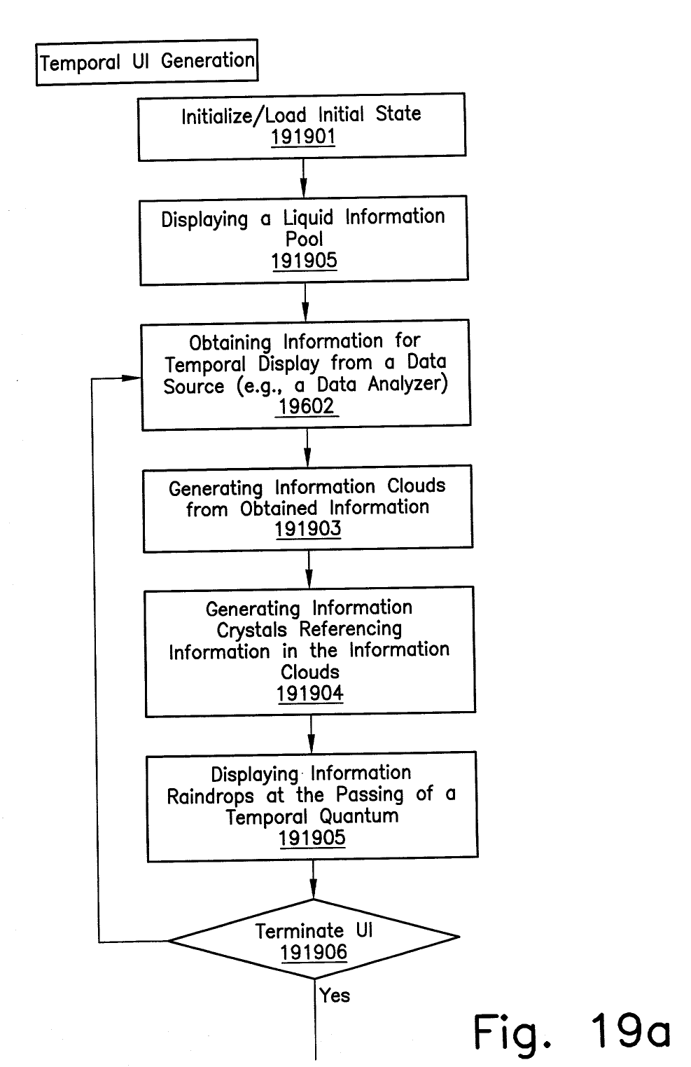

FIG. 18 outlines a liquid temporal user interface (LTUI) flow. Initially, the temporal user interface is loaded an initialized so that it may be engaged 181801. Thereafter, a user may engage the user interface 181802. The user may engage the LTUI by interacting with any number of conventional user peripheral devices such as directing a pointer through a device, e.g., a mouse. As the user interacts with the LTUI, the LTUI checks for user selections 181803, e.g., checking for user drags for creating ripples. Thereafter, the LTUI will update its internal state depending upon any selections 181804. Upon updating its state, the LTUI will redraw the display reflecting the updated state 181805. Thereafter, the LTUI may check for a termination event, e.g., the user requesting to quit the LTUI 181805. If there is no termination event then iteration will continue with the LTUI checking for any new user selections 181803. If there is a termination event 181805, then the LTUI will save its state 181806. The LTUI may employ standard data structures, such as custom structs, arrays, lists, and frozen objects. Upon saving the LTUI state 181806, the LTUI clears its state 181807 and redraws the screen 181808 so as to remove its display elements from the screen and thereafter terminate 181809.

FIG. 18 outlines the display flow of liquid temporal user interface (LTUI). Initially, the temporal user interface is loaded an initialized so that it may be engaged 181801. Thereafter, a user may engage the user interface 181802. The user may engage the LTUI by interacting with any number of conventional user peripheral devices such as directing a pointer through a device, e.g., a mouse. As the user interacts with the LTUI, the LTUI chekcs for user selections 181803, e.g., checking for user drags for creating ripples. Thereafter, the LTUI will update its internal state depending upon any selections 181804. Upon updating its state, the LTUI will redraw the display reflecting the updated state 181805. Thereafter, the LTUI may check for a termination event, e.g., the user requesting to quit the LTUI 181805. If there is no termination event then iteration will continue with the LTUI checking for any new user selections 181803. If there is a termination event 181805, then the LTUI will save its state 181806. The LTUI may employ standard data structures, such as custom structs, arrays, lists, and frozen objects. Upon saving the LTUI state 181806, the LTUI clears its state 181807 and redraws the screen 181808 so as to remove its display elements from the screen and thereafter terminate 181809.

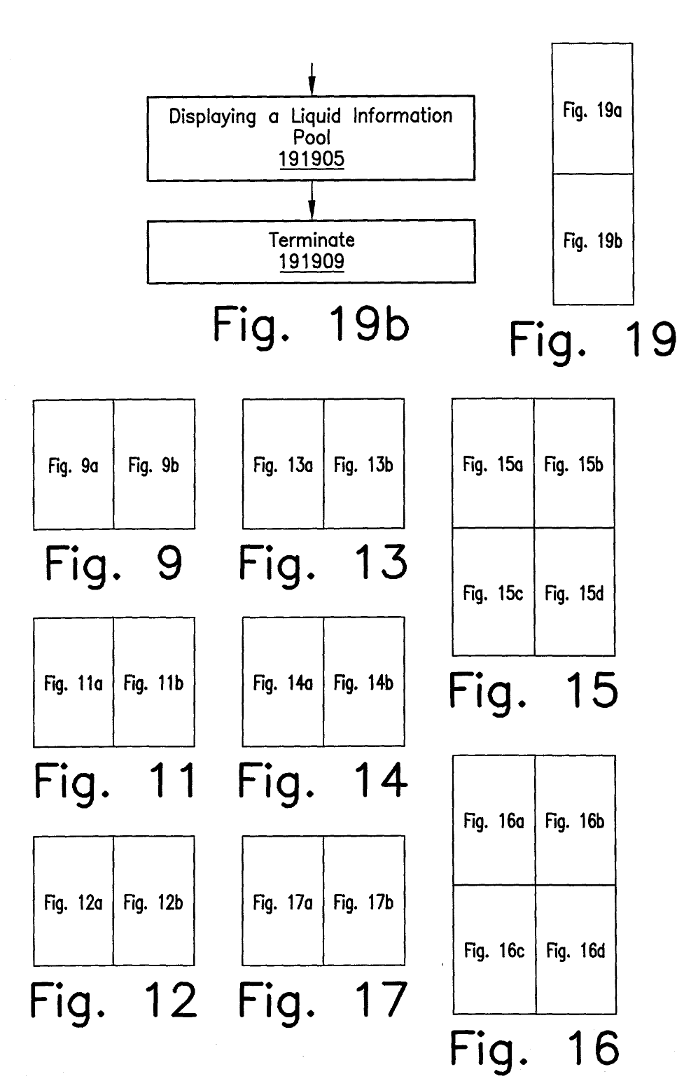

FIG. 19 outlines the generation flow of liquid temporal user interface. Initially, the temporal user interface is loaded an initialized so that it may be engaged 191901. Thereafter, the LTUI is displayed 191905 and FIG. 18. Next, the LTUI obtains information for temporal display from a data source 19602. Although the temporal information may be obtained from any number of data sources, in one non-limiting embodiment, the data source is a data analyzer. Next the LTUI may generate information clouds including the information obtained from the data source 191903. In an alternative embodiment, the LTUI may simply reference the data from the data source. The LTUI passes the information from the data source into a data structure, e.g., a hashtable. Next, the LTUI generates information crystals referencing information in the information clouds that will 191904 that will be used to form raindrops. Formed crystals are then rendered as raindrops at the passing of a temporal quantum by having the LTUI redraw 191905 and FIG. 18. Thereafter, the LTUI may check for a termination event, e.g., the user requesting to quit the LTUI 191906. If there is no termination event then iteration will continue with the LTUI obtaining updated information from a data source 19602. If there is a termination event 191906, then the LTUI will redraw, and as a consequence save its state, 191905 and FIG. 18 and thereafter terminate 191909.

The user may engage the LTUI by interacting with any number of user conventional peripheral devices such as directing a pointer through a device, e.g., a mouse. As the user interacts with the LTUI, the LTUI chekcs for user selections 181803, e.g., checking for user drags for creating ripples. Thereafter, the LTUI will update its internal state depending upon any selections 181804. Upon updating its state, the LTUI will redraw the display reflecting the updated state 181805. Thereafter, the LTUI may check for a termination event, e.g., the user requesting to quit the LTUI 181805. If there is no termination event then iteration will continue with the LTUI checking for any new user selections 181803. If there is a termination event 181805, then the LTUI will save its state 181806. The LTUI may employ standard data structures, such as custom structs, arrays, lists, and frozen objects. Upon saving the LTUI state 181806, the LTUI clears its state 181807 and redraws the screen 181808 so as to remove its display elements from the screen and thereafter terminate 181809.

It should be understood that the above description is only representative of illustrative embodiments. For the convenience of the reader, the above descriptions have focused on a representative sample of all possible embodiments, a sample that teaches the principles of the invention. The description has not attempted to exhaustively enumerate all possible variations. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that the embodiments and variations shown and described herein are merely illustrative of the principles of this invention and that various modifications may be implemented without departing from the scope and spirit of the invention.

What is claimed is:

1. A method of using a computer system to graphically display search results, comprising:
sending a search request to a search engine, wherein the search request includes a navigation location processed into a format required by the search engine;
receiving search results from the search engine, wherein the search results are proximal links related to the navigation location, wherein the proximal links are related to the search request;
displaying the search results in a display area, wherein the search results are represented as graphical shapes drawn in the display area and at any given time represent data for a time quantum, and wherein the graphical shapes reference data and respond to user selections allowing a user to access referenced data.

2. The method of claim 1, wherein the proximal links may be at least one navigation location.

3. The method of claim 1, wherein the proximal links may be a subweb.

4. The method of claim 1, wherein the received proximal links are provided to an output target.

5. The method of claim 1, wherein the graphical shapes are grouped by the inter-relatedness of the data referenced by the graphical shapes.

6. The method of claim 5, wherein the inter-relatedness of the data is represented by graphical shapes, wherein subsequent data containing references within the scope of primary data are represented by subsequent graphical shapes that are enveloped by primary graphical shapes.

7. The method of claim 5, wherein the inter-relatedness of the data is represented by graphical shapes, wherein subsequent data containing no references within the scope of primary data are represented by subsequent graphical shapes that do not intersect and are not enveloped by primary graphical shapes.

8. A system of using a computer to graphically display search results, comprising:
means to send a search request to a search engine, wherein the search request includes a navigation location processed into a format required by the search engine;
means to receive search results from the search engine, wherein the search results are proximal links related to the navigation location, wherein the proximal links are related to the search request;
means to display the search results in a display area, wherein the search results are represented as graphical shapes drawn in the display area and at any given time represent data for a time quantum, and wherein the graphical shapes reference data and respond to user selections allowing a user to access referenced data.

9. The system of claim 8, wherein the proximal links may be at least one navigation location.

10. The system of claim 8, wherein the proximal links may be a subweb.

11. The system of claim 8, wherein the received proximal links are provided to an output target.

12. The system of claim 8, wherein the graphical shapes are grouped by the inter-relatedness of the data referenced by the graphical shapes.

13. The system of claim 12, wherein the inter-relatedness of the data is represented by graphical shapes, wherein subsequent data containing references within the scope of primary data are represented by subsequent graphical shapes that are enveloped by primary graphical shapes.

14. The system of claim 8, wherein the inter-relatedness of the data is represented by graphical shapes, wherein subsequent data containing no references within the scope of primary data are represented by subsequent graphical shapes that do not intersect and are not enveloped by primary graphical shapes.

15. A method of using a computer system for searching for relevant data, comprising:
receiving a search request from a user, wherein the search request includes a search subject and navigation location;
processing the search request into a format required by a search engine;
sending the processed search request to the search engine, wherein the processed search request is processed for the search engine;
receiving search results, which are proximal links, wherein the proximal links are related to the navigation location from the search request;
determining which proximal links are relevant, wherein relevant links are those that are related to the search subject of the search request; and
transmitting the search results to the user.

16. The method of claim 15, further comprising determining if too many proximal links have been found.

17. The method of claim 15, further comprising processing relevant links for output if not too many proximal links have been found.

18. The method of claim 15, further comprising providing the relevant links to an output target.

19. The method of claim 18, wherein the output target is for is a temporal user interface.

20. The method of claim 15, wherein the proximal links may be at least one navigation location.

21. The method of claim 15, wherein the proximal links may be a subweb.

22. A system of using a computer to search for information, comprising:
means to obtain a query, wherein the query includes a search subject and navigation location;
means to process the navigation location into a format required by a search engine;
means to provide the search engine with a location request, wherein the location request is the processed navigation location;
means to obtain navigation location related proximal links, wherein the location proximal links are related to the location request;
means to process the location proximal links for relevance; and
means to identify subject links related to the search subject from the processed location proximal links.

23. The system of claim 22, further comprising means to determine if an expanse breach has occurred.

24. The system of claim 22, further comprising means to process the identified subject links for output if no expanse breach occurred.

25. The system of claim 22, further comprising means to provide the processed proximal links to an output target.

26. The system of claim 25, wherein the output target is for is a temporal user interface.

27. The system of claim 22, wherein the proximal links may be at least one navigation location.

28. The system of claim 22, wherein the proximal links may be a subweb.

29. A method of using a computer to display help information, comprising:
monitoring function execution;
storing a current system state;
determining what functions have been executed by examining latest stored system states if a request for help has been made;
displaying help information based on the functions that have been last executed.

30. The method of claim 29, further comprising determining if the last executed function has been made by mistake.

31. The method of claim 30, wherein the determination that the last executed function has been made by mistake is made by a user engaging an undo function.

32. The method of claim 29, further comprising instantiating a latest stored system state the last executed function has been made by mistake.

33. An interaction computer interface invocable by an application program responsive to user selections to invoke application module commands, comprising:
an information pool;
information clouds, wherein the information clouds are data structures referencing information;
information crystals, wherein the information crystals reference information in information clouds and form at a passing of a temporal quantum;
information raindrops, wherein the information raindrops are information crystals that form in an information pool.

34. The interface of claim 33, wherein a liquid graphic transformation effect is applied to the information pool.

35. The interface of claim 33, wherein the information pool is displayed in a window.

36. The interface of claim 33, wherein a highlighted portion of the information pool is displayed as a subview.

37. The interface of claim 33, wherein the information pool includes a pool bottom.

38. The interface of claim 37, wherein the pool bottom displays multimedia.

39. The interface of claim 37, wherein the pool bottom displays advertising.

40. The interface of claim 33, wherein the information pool displays temporal information.

41. The interface of claim 33, wherein the information clouds reference information from a data analyzer.

42. The interface of claim 33, wherein the information crystals reference navigation locations.

43. The interface of claim 33, wherein the information crystals reference subjects.

44. The interface of claim 33, wherein the information crystals reference multimedia.

45. The interface of claim 33, wherein the information crystals reference a number representing how many alternate navigation locations refer to a particular navigation location.

46. The interface of claim 33, wherein the information raindrops visually appear as analogue to real world raindrops falling into a pool.

47. The interface of claim 33, wherein groups of raindrops represent groups of data in a subweb.

48. The interface of claim 33, wherein the appearance of a raindrop may vary based on specified criteria.

49. The interface of claim 33, wherein the appearance of a raindrop may vary in color.

50. The interface of claim 33, wherein the appearance of a raindrop may vary in size.

51. The interface of claim 33, wherein the appearance of a raindrop may vary in thickness.

52. The interface of claim 33, wherein the appearance of a raindrop may vary in transparency.

53. The interface of claim 33, wherein the appearance of a raindrop may be complimented with complementary dynamic visual cues.

54. The interface of claim 48, wherein a specified criterion is the type of a document.

55. The interface of claim 48, wherein a specified criterion is a size of a document.

56. The interface of claim 48, wherein a specified criterion is a number representing how many alternate navigation locations refer to a particular navigation location.

57. The interface of claim 48, wherein a specified criterion is a number of multimedia files at a navigation location.

58. The interface of claim 48, wherein a specified criterion is staleness of a link.

59. The interface of claim 48, wherein a specified criterion is a media content type.

60. The interface of claim 48, wherein a specified criterion is a subject relevancy ranking.

61. The interface of claim 48, further comprising a dynamic mapping and search selection facility.

62. The interface of claim 61, wherein the search selection facility allows modification of the specified criteria.

63. The interface of claim 33, further comprising a time line facility.

64. The interface of claim 33, further comprising an interpretive help tool.

65. The interface of claim 33, further comprising a focus box.

66. The interface of claim 33, further comprising a skimming pebble facility.

67. A method of using a computer to display data, comprising:
displaying an information pool;
receiving information from a data source;
generating information clouds, wherein the information clouds are data structures referencing information obtained from the data source;
generating information crystals, wherein the information crystals reference information in information clouds and form at a passing of a temporal quantum; and
displaying information raindrops, wherein the information raindrops are information crystals that form in an information pool.

68. The method of claim 67, wherein the data source is a data analyzer.

69. The method of claim 67, further comprising applying a liquid graphic transformation effect to the information pool.

70. The method of claim 67, wherein the information pool is displayed in a window.

71. The method of claim 67, wherein a highlighted portion of the information pool is displayed as a subview.

72. The method of claim 67, wherein the information pool includes a pool bottom.

73. The method of claim 72, further comprising displaying multimedia in the pool bottom.

74. The method of claim 72, further comprising displaying advertising in the pool bottom.

75. The method of claim 67, further comprising displaying temporal information in the information pool.

76. The method of claim 67, wherein the information clouds obtain information from a data analyzer.

77. The method of claim 67, wherein the information crystals reference navigation locations.

78. The method of claim 67, wherein the information crystals reference subjects.

79. The method of claim 67, wherein the information crystals reference multimedia.

80. The method of claim 67, wherein the information crystals reference a number representing how many alternate navigation locations refer to a particular navigation location.

81. The method of claim 67, wherein the information raindrops visually appear as analogue to real world raindrops falling into a pool.

82. The method of claim 67, wherein groups of raindrops represent groups of data in a subweb.

83. The method of claim 67, wherein the appearance of a raindrop may vary based on specified criteria.

84. The method of claim 67, wherein the appearance of a raindrop may vary in color.

85. The method of claim 67, wherein the appearance of a raindrop may vary in size.

86. The method of claim 67, wherein the appearance of a raindrop may vary in thickness.

87. The method of claim 67, wherein the appearance of a raindrop may be complimented with complementary dynamic visual cues.

88. The method of claim 67, wherein the appearance of a raindrop may vary in translucency.

89. The method of claim 83, wherein a specified criterion is the type of a document.

90. The method of claim 83, wherein a specified criterion is a size of a document.

91. The method of claim 83, wherein a specified criterion is a number representing how many alternate navigation locations refer to a particular navigation location.

92. The method of claim 83, wherein a specified criterion is a number of multimedia files at a navigation location.

93. The method of claim 83, wherein a specified criterion is staleness of a link.

94. The method of claim 83, wherein a specified criterion is a media content type.

95. The method of claim 83, wherein a specified criterion is a subject relevancy ranking.

96. The method of claim 83, further comprising a dynamic mapping and search selection facility.

97. The method of claim 96, wherein the search selection facility allows modification of the specified criteria.

98. In memory, an interaction interface invocable by an application program responsive to user selections to invoke application module commands, comprising:
a graphical shape to represent temporal information;
a display area to display the graphical shapes,
wherein the graphical shapes drawn in the display area at any given time represent data for a time quantum,
wherein the graphical shapes reference data and respond to user selections allowing a user to access referenced data;
a temporal selection facility to specify any given time quantum in a chronological data set responsive to user selections,
wherein the temporal selection facility is disposed in communication with the display area such that user selections specifying a time quantum instruct the display area to display temporal information for a specified time quantum from a chronological data set.

99. The interface of claim 98, wherein a liquid graphic transformation effect is applied to the display area.

100. The interface of claim 98, wherein the display area is displayed in a window.

101. The interface of claim 98, wherein a highlighted portion of the display area is displayed as a subview.

102. The interface of claim 98, wherein the display area includes a lower display layer.

103. The interface of claim 102, wherein the lower display layer displays multimedia.

104. The interface of claim 102, wherein the lower display layer displays advertising.

105. The interface of claim 98, wherein the display area displays temporal information.

106. The interface of claim 98, wherein the chronological data set is obtained from a data analyzer.

107. The interface of claim 98, wherein the data the shapes reference navigation locations.

108. The interface of claim 98, wherein the data the shapes reference multimedia.

109. The interface of claim 98, wherein the shapes reference data from a chronological data set.

110. The interface of claim 98, wherein the shapes visually appear as analogue to real world raindrops falling into a pool.

111. The interface of claim 98, wherein groups of shapes represent groups of data in a subweb.

112. The interface of claim 98, wherein the appearance of a shape may vary based on specified criteria.

113. The interface of claim 98, wherein the appearance of a shape may vary in color.

114. The interface of claim 98, wherein the appearance of a shape may vary in size.

115. The interface of claim 98, wherein the appearance of a shape may vary in thickness.

116. The interface of claim 98, wherein the appearance of a shape may vary in transparency.

117. The interface of claim 98, wherein the appearance of a shape may be complimented with complementary dynamic visual cues.

118. The interface of claim 112, wherein a specified criterion is the type of a document.

119. The interface of claim 112, wherein a specified criterion is a size of a document.

120. The interface of claim 112, wherein a specified criterion is a number representing how many alternate navigation locations refer to a particular navigation location.

121. The interface of claim 112, wherein a specified criterion is a number of multimedia files at a navigation location.

122. The interface of claim 112, wherein a specified criterion is staleness of a link.

123. The interface of claim 112, wherein a specified criterion is a media content type.

124. The interface of claim 112, wherein a specified criterion is a subject relevancy ranking.

125. The interface of claim 98, further comprising a dynamic mapping and search selection facility.

126. The interface of claim 125, wherein the search selection facility allows modification of the specified criteria.

127. The interface of claim 98, further comprising an interpretive help tool.

128. The interface of claim 98, further comprising a focus box.

129. The interface of claim 98, further comprising a skimming pebble facility.

130. The interface of claim 98, wherein the graphical shapes are grouped by the inter-relatedness of the data referenced by the graphical shapes.

131. The interface of claim 130, wherein the inter-relatedness of the data is represented by graphical shapes, wherein subsequent data containing references within the scope of primary data are represented by subsequent graphical shapes that are enveloped by primary graphical shapes.

132. The interface of claim 130, wherein the inter-relatedness of the data is represented by graphical shapes, wherein subsequent data containing no references within the scope of primary data are represented by subsequent graphical shapes that do not intersect and are not enveloped by primary graphical shapes.

133. The interface of claim 130, wherein the inter-relatedness of the data is represented by graphical shapes, wherein subsequent data containing some references within the scope of primary data and some references outside the scope of primary data are represented by subsequent graphical shapes that intersect with primary graphical shapes.
